(19) United States
(12) Patent Application Publication
(10) Pub. No.: US 2026/0124746 A1
(43) Pub. Date: May 7, 2026

(54) TRAINING AND USE OF A BIPEDAL ACTION MODEL FOR HUMANOID ROBOT

(71) Applicant: Figure AI Inc., San Jose, CA (US)

(72) Inventors: Corey Lynch, San Jose, CA (US); Toki Migimatsu, San Jose, CA (US); Yevgen Chebotar, San Jose, CA (US); Michael Ahn, San Jose, CA (US); Ivan Babushkin, San Jose, CA (US)

(21) Appl. No.: 19/378,308

(22) Filed: Nov. 3, 2025

Related U.S. Application Data
(63) Continuation-in-part of application No. 19/319,712, filed on Sep. 4, 2025, now Pat. No. 12,578,733.
(60) Provisional application No. 63/715,270, filed on Nov. 1, 2024.
(60) Provisional application No. 63/722,057, filed on Nov. 18, 2024.
(60) Provisional application No. 63/725,279, filed on Nov. 26, 2024.
(60) Provisional application No. 63/760,617, filed on Feb. 19, 2025.
(60) Provisional application No. 63/776,429, filed on Mar. 24, 2025.
(60) Provisional application No. 63/801,451, filed on May 7, 2025.
(60) Provisional application No. 63/819,533, filed on Jun. 6, 2025.
(60) Provisional application No. 63/860,403, filed on Aug. 8, 2025.
(60) Provisional application No. 63/860,580, filed on Aug. 8, 2025.
(60) Provisional application No. 63/905,666, filed on Oct. 26, 2025.
(60) Provisional application No. 63/905,711, filed on Oct. 26, 2025.

(51) Int. Cl. B25J 9/16

(52) U.S. Cl. CPC B25J 9/163; B25J 9/161; B25J 9/1674

(57) ABSTRACT

The present disclosure provides a method for controlling a humanoid robot using a hierarchical bipedal action model (BAM), the method comprising obtaining a base controller by training in simulation with reinforcement learning, instantiating an initial BAM including a Gamma model configured to generate intermediate goals, a Beta model configured to translate the intermediate goals into task-space actions, and an Alpha model configured to translate the task-space actions and robot state into motor commands, deploying the initial BAM such that at least the Alpha model executes on-board the humanoid robot, causing the humanoid robot to perform an initial task and logging sensor and control data to form a first dataset, based on the first dataset, training at least one policy of the BAM to generate a refined BAM, and deploying the refined BAM to control the humanoid robot autonomously.

### CROSS-REFERENCE TO RELATED APPLICATIONS

This application claims the benefit of and priority to U.S. Provisional Patent Application Nos. 63/715,270, filed Nov. 1, 2024, 63/722,057, filed Nov. 18, 2024, 63/725,279, filed Nov. 26, 2024, 63/753,670, filed Feb. 4, 2025, 63/760,617, filed Feb. 19, 2025, 63/776,429, filed Mar. 24, 2025, 63/801,451, filed May 7, 2025, 63/819,533, filed Jun. 6, 2025, 63/860,403, filed Aug. 8, 2025, 63/860,580, filed Aug. 8, 2025, 63/905,666, filed Oct. 26, 2025 and 63/905,711, filed Oct. 26, 2025, each of which is expressly incorporated by reference herein in its entirety.

### TECHNICAL FIELD

This disclosure relates to systems, methods, and techniques for using reinforcement learning (RL) to train a bipedal action model(s) (BAMs) for use with a general-purpose humanoid robot (e.g., a humanoid, a robot).

### BACKGROUND

Robots are increasingly utilized to automate tasks in various industries, from manufacturing to logistics and beyond. Many conventional robotic systems, such as wheeled robots or stationary articulated arms, are highly specialized for a narrow set of tasks in structured, predictable environments. While effective for their specific purpose, these non-humanoid forms typically lack the versatility and mobility required to perform a diverse array of generalized tasks in environments designed for humans, such as navigating stairs, retrieving items from shelves, or interacting with standard tools and interfaces. The development of humanoid robots aims to address this gap by providing a form factor that can operate in human spaces and perform human-like movements. However, creating a functional, general-purpose humanoid robot presents immense technical challenges. Simply adopting or modifying the structures and kinematic principles from non-humanoid systems is often insufficient, as these theoretical designs are not tethered to the complex realities of design, testing, and manufacturing a stable and capable bipedal system.

Conventional control systems for existing robots often face significant limitations, particularly in dynamic and unstructured environments. Many traditional robotic systems rely on pre-programmed responses or behaviors. These systems struggle to adapt in real-time to unforeseen obstacles or changes in their surroundings. Other systems rely on remote processing for complex decision-making, which can introduce significant latency, leading to delays and inappropriate actions in dynamic situations. Some control approaches utilize “binned pose systems” or other discretized action spaces, which can result in discontinuous, “jittery” motions rather than the fluid, continuous whole-body control required for complex manipulation and locomotion. These conventional systems often fail to provide the real-time, context-aware decision-making necessary for robust autonomous operation.

Training such complex robots also presents a major hurdle. Training a control policy entirely on a physical robot is often impractical from a time perspective and can be unsafe for the robot and its surroundings. Consequently, training is often performed in a simulated environment. This, however, introduces the well-known “sim-to-real” gap-a discrepancy between the idealized physics of a simulator and the complex, noisy dynamics of the real world. A policy trained exclusively in simulation may fail when deployed on physical hardware. Moreover, common training methods like pure reinforcement learning (RL) can be highly sample-in-efficient, requiring an impractical volume of interactions to learn complex skills. Therefore, there is a significant need in the art for an improved control architecture and training methodology for humanoid robots.

### SUMMARY

The presently disclosed subject matter is directed to a method for controlling a humanoid robot using a hierarchical bipedal action model (BAM). Particularly, the method comprises obtaining a base controller by training in simulation with reinforcement learning. The method includes instantiating an initial BAM including a Gamma model configured to generate intermediate goals, a Beta model configured to translate the intermediate goals into task-space actions, and a Alpha model configured to translate the task-space actions and robot state into motor commands. The method includes deploying the initial BAM such that at least the Alpha model executes on-board the humanoid robot. The method includes causing the humanoid robot to perform an initial task and logging sensor and control data to form a first dataset. The method includes, based on the first dataset, training at least one policy of the BAM to generate a refined BAM. The method includes deploying the refined BAM to control the humanoid robot autonomously.

The presently disclosed subject matter is directed to a system for controlling a humanoid robot using a hierarchical bipedal action model (BAM). Particularly, the system comprises a Gamma model configured to receive multimodal inputs and generate intermediate goals. The system includes a Beta model configured to translate the intermediate goals into task-space actions. The system includes a Alpha model configured to translate the task-space actions and robot state into motor commands. The Alpha model is trained with a reward function including at least one of joint-pose accuracy, angular-velocity consistency, momentum management, center-of-mass trajectory alignment, and energy-efficiency terms.

The presently disclosed subject matter is directed to a humanoid robot. Particularly, the humanoid robot comprises a bipedal robotic body including a plurality of joints and actuators. The humanoid robot includes one or more sensors configured to collect sensor data from the robotic body and an external environment. The humanoid robot includes an onboard computing architecture communicatively coupled to the actuators and the one or more sensors. The humanoid robot includes a memory storing a bipedal action model, the bipedal action model being an initial model trained by a remote system using offline reinforcement learning. The onboard computing architecture is configured to execute the bipedal action model to perform an initial task, collect a first dataset from the one or more sensors based on performing the initial task, determine a failure to complete the initial task, in response to the determined failure, autonomously generate and execute one or more self-correcting tasks based on the sensor data, collect one or more self-correction datasets from the one or more sensors based on performing the one or more self-correcting tasks, and finetune the bipedal action model using the first dataset and the one or more self-correction datasets to generate a finetuned bipedal action model.

The presently disclosed subject matter is directed to a method for training a bipedal action model for controlling a humanoid robot. Particularly, the method comprises obtaining training data. The method includes training one or more Alpha models of the bipedal action model using the training data and reinforcement learning techniques in a simulated environment, wherein the simulated environment includes a digital representation of the humanoid robot with modeled geometry, mass distribution, moments of inertia, joints, and actuators. The method includes running the bipedal action model on the humanoid robot to collect data by performing an initial task and generating a first dataset based on actions performed to complete the initial task. The method includes finetuning the bipedal action model based on the collected data using reinforcement learning techniques. The method includes outputting the finetuned bipedal action model for deployment on the humanoid robot.

The presently disclosed subject matter is directed to a system for controlling a humanoid robot using a hierarchical bipedal action model. Particularly, the system comprises a Gamma model configured to receive natural language instructions and decompose them into intermediate goals. The system includes a Beta model configured to receive the intermediate goals from the Gamma model and translate them into task-space actions. The system includes an Alpha model configured to receive the task-space actions from the Beta model and translate them into low-level motor commands for the humanoid robot. The Alpha model is trained using reinforcement learning techniques with a reward function that includes joint positional accuracy, angular velocity consistency, momentum management, center-of-mass trajectory alignment, and energy efficiency components.

The presently disclosed subject matter is directed to a method for online finetuning of a bipedal action model deployed on a humanoid robot. Particularly, the method comprises executing the bipedal action model at the humanoid robot to complete a task. The method includes collecting data for a first dataset based on executing the bipedal action model. The method includes determining whether the humanoid robot completed the task. The method includes, when the humanoid robot fails to complete the task, collecting data for additional datasets based on the humanoid robot performing self-correction tasks. The method includes finetuning the bipedal action model using reward-based learning methods based on the collected datasets. The method includes deploying the finetuned bipedal action model when a success rate exceeds a threshold level.

The presently disclosed subject matter is directed to a computer-readable medium storing instructions that, when executed by a processor, cause the processor to perform a method for training a reinforcement learning policy for humanoid robot control. Particularly, the method comprises defining a state space including robot proprioception data, history of recent observations, and task commands. The method includes defining an action space specifying target joint positions or target joint torques. The method includes defining a reward function comprising weighted components for joint accuracy, smoothness, momentum, balance, and energy efficiency. The method includes initializing a reinforcement learning algorithm and associated neural networks. The method includes training the reinforcement learning policy in a simulated environment using the defined state space, action space, and reward function.

The presently disclosed subject matter is directed to a humanoid robot control system. Particularly, the system comprises sensors configured to collect robot sensor data. The system includes a computing architecture configured to execute a bipedal action model comprising multiple hierarchical layers. The bipedal action model is trained using reinforcement learning techniques with domain randomization applied to robot properties and environmental conditions. The bipedal action model is configured to process multimodal inputs including the robot sensor data and user commands to generate motor control signals. The bipedal action model is continuously finetuned based on failure identification and self-correction data collected during real-world operation.

The presently disclosed subject matter is directed to a method for generating training data for humanoid robot control. Particularly, the method comprises importing a digital model of a humanoid robot into a simulator, wherein the digital model includes geometry, mass distribution, moments of inertia, joints, and actuators of the humanoid robot. The method includes applying domain randomization to vary robot properties and environmental conditions including ground friction, terrain characteristics, and external perturbations. The method includes generating reference trajectories using at least one of motion capture data, model predictive control, or trajectory optimization. The method includes defining imitation tasks with varying levels of reference data including target joint positions, velocities, and torques. The method includes collecting training data through simulated interactions between the digital model and the randomized environment.

The presently disclosed subject matter is directed to a bipedal action model for humanoid robot control. Particularly, the model comprises a first layer configured to perform high-level semantic reasoning and long-horizon planning by decomposing natural language instructions into intermediate goals. The model includes a second layer configured to perform short-horizon planning by translating the intermediate goals into task-space actions. The model includes a third layer configured to perform real-time low-level motion control by translating the task-space actions into motor commands while maintaining balance and joint limit constraints. Each layer operates at a different frequency and the third layer is trained using reinforcement learning with a composite reward function that encourages physically plausible and stable motions.

In some embodiments, a bipedal action model (BAM) stored in memory comprises a hierarchical architecture with multiple layers, such as a high-level (Gamma) policy, a mid-level (Beta) policy, and a low-level (Alpha) policy. These policies, in some embodiments, operate at different update rates with a relative ordering of high-level<mid-level<low-level. In some embodiments, the high-level Gamma model is a vision-language model (VLM) operating at a frequency (e.g., 0.1-20 Hz) with a large parameter count (e.g., 500M-200B), configured to decompose natural-language instructions into intermediate goals, which may be natural-language descriptions or latent representations; it may use a vision encoder (e.g., with temporal attention), a language encoder (e.g., with bidirectional transformer layers), and a fusion module. In some embodiments, the mid-level Beta model is a vision-language-action (VLA) model operating at a frequency (e.g., 1-20 Hz) with a parameter count (e.g., 100M-10B), potentially finetuned for the robot's morphology. It receives intermediate goals and outputs task-space actions-which, in some embodiments, include target end-effector poses (3D coordinates and orientations), base velocity/locomotion commands, and gaze targets—or probability distributions over discrete action tokens, based on multimodal inputs like camera frames and proprioceptive states. In some embodiments, the low-level Alpha model operates at a high frequency (e.g., 20-1000 Hz) to translate these task-space commands into low-level motor commands, such as joint positions, joint velocities, or joint torques.

In some embodiments, the initial model is trained in a simulated environment using simulation training that employs domain randomization to bridge the sim-to-real gap. This domain randomization, in some embodiments, includes variations to robot geometry (e.g., arm length, hand weight), mass distributions (e.g., link masses, center-of-mass positions), actuator/motor characteristics (e.g., limits, friction coefficients, torque limits), contact properties, sensor noise (e.g., IMU drift, encoder accuracy), environmental conditions (e.g., ground friction 0.1-1.5, slopes 0-30 degrees, uneven surfaces up to 5 cm), and external perturbations (e.g., lateral forces up to 50N). In some embodiments, at least one policy is trained or fine-tuned using reinforcement learning (RL) algorithms like Proximal Policy Optimization (PPO), Deep Deterministic Policy Gradient (DDPG), or Soft Actor-Critic (SAC). The PPO algorithm, in some embodiments, uses multi-layer perceptron (MLP) neural networks (e.g., 2-20 hidden layers with 64-2,560 units, ReLU activations). In some embodiments, training also uses imitation data from sources like motion capture (e.g., 60-240 Hz sampling), teleoperation demonstrations, model-predictive control (MPC) trajectories (e.g., 0.5-2.0s horizons), or trajectory optimization outputs (e.g., using energy minimization), which may define reference trajectories.

In some embodiments, the training (e.g., for the Alpha model) employs a composite reward function. This function, in some embodiments, includes at least a joint-pose accuracy term, which may be an exponentially-weighted pose error or penalize differences using mean squared error (MSE) calculations between simulated and reference joint angles. In some embodiments, the reward function further includes one or more of: (i) angular-velocity consistency terms (e.g., based on an L2 norm or penalizing deviations from reference velocities), (ii) momentum-management terms comparing centroidal linear and angular momentum to reference values or trajectories, (iii) center-of-mass (COM) trajectory alignment (e.g., minimizing Euclidean distance between simulated and reference positions), and (iv) energy-efficiency penalties, which in some embodiments penalize power usage calculated as a sum of torque multiplied by angular velocity across all joints.

In some embodiments, the method supports finetuning the refined BAM, which can occur via the onboard computing architecture or by transmitting datasets (e.g., self-correction datasets) to a remote computing system. In some embodiments, this involves detecting a failure to complete an initial task, which may comprise processing historical data (e.g., image frames, proprioception data) using image recognition or object detection to compare a current state to a goal state. Upon failure, the system, in some embodiments, autonomously generates one or more self-correcting tasks. In some embodiments, generating these tasks comprises analyzing stored imagery, proprioception, and memory data associated with the task, comparing current robot and object poses to target endpoints, and producing corrective action sequences. In some embodiments, finetuning comprises collecting additional datasets during these self-correction tasks and applying reward-based learning using feedback selected from human preference or ranking of actions, automated labeling model annotations, and scalar or binary task-success signals. This process, in some embodiments, continues iteratively until an operator-specified success criterion or predetermined threshold level (e.g., 99-100%) is met.

In some embodiments, deploying the refined BAM comprises retaining the model in on-board memory for local execution and transmitting the refined BAM over a network for deployment on additional humanoid robots, enabling fleet-wide updates. In some embodiments, the system utilizes sensors including cameras (for image frames), inertial measurement units (configured to measure base velocity, projected gravity vector), and joint encoders (configured to measure current joint positions/velocities). This robot proprioception data, in some embodiments, provides temporal context spanning multiple timesteps for motion dynamics information. In some embodiments, the system further comprises a safety monitor configured to override or gate lower-level commands when safety thresholds (e.g., for joint limits, contact forces, stability margins) are exceeded. In some embodiments, joint-torque limits are enforced with soft constraints that increase resistance as torques approach a configurable fraction of a rated maximum.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command or be commanded by, control or be controlled by, and/or interact;

FIG. 2 is a block diagram illustrating components of the humanoid robot of FIG. 1;

FIG. 3A is a perspective view of the humanoid robot of FIGS. 1-2;

FIG. 3B is a diagram illustrating actuators contained within the humanoid robot of FIG. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a diagram depicting an interaction of components contained within a computing architecture of the humanoid robot of FIGS. 1-3B;

FIG. 10 is a flowchart illustrating the process for training, finetuning and deploying a bipedal action model (BAM) with reinforcement learning;

FIGS. 11-13 is a flowchart illustrating a process of training BAM using offline reinforcement learning (RL) in a simulator;

FIG. 14 is a diagram illustrating an exemplary deployment of a three-layer BAM, where the Alpha model is the output of the training process in FIGS. 11-13;

FIG. 15 is a flowchart illustrating a process for finetuning the BAM with online RL techniques on a humanoid robot;

FIG. 16 is a diagram illustrative an example of a task performed by a humanoid robot using the RL-trained BAM in order to complete the task; and

FIG. 17 is a diagram of a decision tree of a RL-trained BAM that is deployed at a humanoid robot to complete a task.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

Described herein are systems, methods, and techniques for training models that control humanoid robots, such as BAMs, with reinforcement learning and reward-based techniques. The disclosed technology includes offline and onboard training techniques, which can be used to improve accuracy of the BAMs in completing tasks and self-correcting when mistakes are made whilst completing said tasks. The disclosed training can incorporate transfer learning techniques so that a humanoid robot can transfer its learnings from completing particular tasks and self-correcting mistakes made whilst completing the particular tasks to other, similar types of tasks that arise during runtime. Training the BAM with RL techniques allows for the humanoid robot to come up with, in real-time, sub-tasks that may be performed in order to complete a particular task where a mistake is made during completion of the particular task. As a result, the humanoid robot can self-correct mistakes or other errors and perform any quantity of sub-tasks in order to ensure completion of the particular task. Training the BAM in this RL setting can beneficially cause the humanoid robot to learn how to correct mistakes that it makes in real-time, during runtime deployment.

In conventional training systems, when a robot fails to complete a particular task, the training may restart from a known stopping point or position. As an illustrative example, if the robot is tasked with moving a piece of metal from a rack to a jig and drops the metal on the ground whilst moving between the rack and the jig, the conventional training system would require the robot to start over from picking up the piece of metal on the rack because the position of the metal on the rack is known (whereas the position of the metal on the ground is unknown). As a result, the conventional training system is inefficient in both resource consumption and time. Moreover, the conventional training system requires human intervention and human correction, which causes increased inefficiencies in resource consumption and time. The disclosed technology, on the other hand, provides technical solutions to improve training of the robot by leveraging RL techniques. The disclosed technology advantageously eliminates human intervention altogether, thereby allowing the robot to self-train such that the robot learns how to self-correct to complete the particular task. Data can be collected as the robot performs failure-based tasks in order to complete the particular task. The collected data can be used to further train the robot's BAM to learn how to self-correct when mistakes are made during runtime for other types of similar tasks. Moreover, the robot can self-correct based on processing its own memory, identifying when the robot has made a mistake and thus has not completed the particular task, and determine and execute failure-based tasks based on its memory and a current location of the robot relative to objects associated with completing the task.

The disclosed inventions are implemented in a tangible humanoid robot comprising a bipedal body with joints and actuators, a suite of onboard sensors, and an onboard computing architecture that stores and executes a bipedal action model (BAM). The BAM is a hierarchical control stack with distinct high-level (Gamma), mid-level (Beta), and low-level (Alpha) policies. This architecture is functionally implemented to operate at different, specified update rates; for example, the high-level Gamma policy, which may be a Vision-Language Model (VLM) for high-level reasoning, operates at a low frequency (e.g., 0.1-20 Hz), while the low-level Alpha policy operates at a high, real-time control frequency (e.g., 20-1000 Hz). A key technical feature is that at least the low-level Alpha policy executes on the robot's onboard computing architecture—that is, at the edge. This on-edge deployment provides real-time analysis and processing of data from many sources, which reduces processing time and improves consumption of available resources on the edge, enabling seamless determination and control. This allows robot controls to be determined, executed, and adapted in real-time, even when network communications are weak or nonexistent. This provides a technical solution to networking interruptions not realized by conventional systems reliant on remote processing. This architecture allows the bipedal humanoid robot to be commanded in natural language and to generalize to new high-rate and continuous control of bimanual behaviors via language prompting without requiring conventional computer coding or scripting. The system provides direct, continuous whole-body control, which technically solves the problem of “discontinuous, ‘jittery’ motions” found in conventional discretized or “binned pose systems”. The system also employs “action chunking” to maintain temporal consistency and reduce command jitter. The system further includes a tangible safety monitor that gates or overrides lower-level commands when specific, measured physical thresholds (e.g., joint limits, contact forces, stability margins) are exceeded.

The disclosed system is inseparably tied to the specific physical machine it controls. The Alpha model's output is not abstract data; it generates specific, physical motor commands-such as joint positions, joint velocities, or joint torques-sent directly to the robot's physical actuators. The system is configured to receive and process data from a suite of onboard physical sensors, including cameras, inertial measurement units (IMUs), and joint encoders. The control stack provides specific technical functions, such as integrating impedance and force control at physical contact points to regulate interaction forces (measured in Newtons), performing online estimation of physical ground friction and the robot's center-of-pressure to prevent slips, and enforcing per-actuator thermal and current limits in real time. The system uses live telemetry from the robot's hardware (e.g., power bus voltage and current) to continuously optimize measurable machine quantities, such as energy consumption, time-to-completion, and component wear, and is configured to re-plan trajectories based on this live telemetry.

The method for generating the control model involves a specific, technical training pipeline tied to the robot's hardware. Policies are trained using datasets synchronized to the robot's ground-truth torque and position logs and perception data from the same sensor suite used during operation. The trained policies are then compiled and quantized for the specific onboard accelerator (e.g., NPU/GPU) and validated with hardware-in-the-loop testing to meet deterministic, real-time cycle-time and jitter constraints. The training uses a high-fidelity, physics-based simulation of the robot, including its geometry, mass distribution, moments of inertia, joints, and actuators. To solve the known technical problem of the “sim-to-real” gap, this training employs domain randomization with specific quantitative ranges for physical parameters, such as ground friction (e.g., 0.1-1.5), slopes (e.g., 0-30 degrees), and external lateral forces (e.g., up to 50N). Training is guided by a composite reward function specified with physics-meaningful components, including joint-pose accuracy, angular-velocity consistency, momentum management (comparing centroidal linear and angular momentum), center-of-mass trajectory alignment, and energy-efficiency (calculated as the sum of torque multiplied by angular velocity across all joints). This training uses specific RL algorithms (e.g., PPO, DDPG, SAC) with defined neural network architectures (e.g., MLPs with 2-20 hidden layers and 64-2,560 units) and is bootstrapped from specific imitation data sources (e.g., motion capture, teleoperation demonstrations, or MPC trajectories).

The disclosed technology provides one or more of the following advantages. For example, the use of RL training techniques enables the humanoid robot to learn from its interactions with an environment without constant human guidance or intervention. This allows for faster, more efficient, less time consuming, less resource consuming, and scalable training across various tasks and environments. Likewise, the robot can learn faster by exploring and optimizing their strategies autonomously, without human intervention, which can lead to the discovery of solutions that humans may not consider. The disclosed technology further causes the robot to adapt to new situations and unexpected changes in an operating environment, both more effectively and more efficiently. As a result, the robot can learn to automatically adjust its actions (e.g., tasks or sub-tasks being performed) based on real-time feedback, rather than relying on pre-programmed responses and/or human intervention. As a result, the robot can learn to adjust its actions immediately based upon outcomes of their previous actions. Such real-time learning is crucial in dynamic environments. The absence of human intervention reduces risk of bias or other limitations that may arise when a human is involved in training. Since the robot learns directly from real-time feedback, data and its own actions, the robot can learn to perform more robust and generalized behaviors that can be transferred to any array of similar, or even dissimilar, tasks.

Advantageously, once deployed, the robot can continue to learn and improve its performance over time using the disclosed RL training techniques. The RL training techniques also are well-suited for solving complex tasks where conventional programming or robot training systems are infeasible. Continuous training with RL allows for the robot to discover new strategies for problem-solving, which was not possible with conventional robot training systems. Additionally, the disclosed technology allows for a bipedal humanoid robot to be commanded in natural language to generalize to new high-rate and continuous control of bimanual behaviors via language prompting without requiring conventional computer coding or scripting. This overcomes a significant limitation of conventional robots because said conventional robots were unable to generalize their previous data sets to perform tasks in unseen environments, regarding unseen objects, or unseen backgrounds. As such, the disclosed technology provides technical solutions to such technical problems.

The disclosed technology provides real-time analysis and processing of data from many sources using comprehensive, trained BAMs that are deployed on the edge (e.g., at the robot). These complex and uniquely trained BAMs or other similar models reduce processing time and improve consumption of available resources on the edge at the robot, thereby allowing for seamless determination and control of the robot. The generation and training described herein can enable the BAMs to perform respective tasks more effectively and more efficiently than the conventional systems for controlling the robot. The disclosed technology leverages the comprehensive and trained BAMs to determine actions to be performed by the robot in real-time, as the robot is performing actions or tasks that are determined in real-time. This downstream use of model output advantageously reflects a solution to technical issues related to conventional systems and thus can improve existing technology for controlling humanoids and other types of robots. In other words, conventional systems may not accurately determine the next actions to be performed by the robot in real-time, especially as the robot is performing actions and when the robot makes a mistake. This edge processing provides lightweight and fast results with the available compute resources, allowing for accurate and seamless movement of the robot to perform the human-desired task in real-time.

The disclosed technology further includes non-transitory computer-readable media storing instructions that, when executed, perform these specific training and control methods. These operations are not of a nature that can be reasonably performed in the human mind. A human is incapable of continuously receiving and processing thousands of disparate data points from a multitude of different sensor sources simultaneously (e.g., human speech, cameras, motion sensors, torque sensors, inertial units). The human mind cannot analyze and tokenize these data points in real-time using complex, trained BAMs, nor can it generate the high-frequency (e.g., up to 1000 Hz), continuous, whole-body motor control signals necessary for seamless, dynamically stable physical action. Furthermore, a human cannot iteratively process this volume of disparate data as the robot performs actions to determine, in real-time, the next set of movements or to autonomously generate failure-based corrective tasks. This downstream use of the model output to control physical actuators in real-time is a specific technical solution to problems in robotic control.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the bipedal or humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

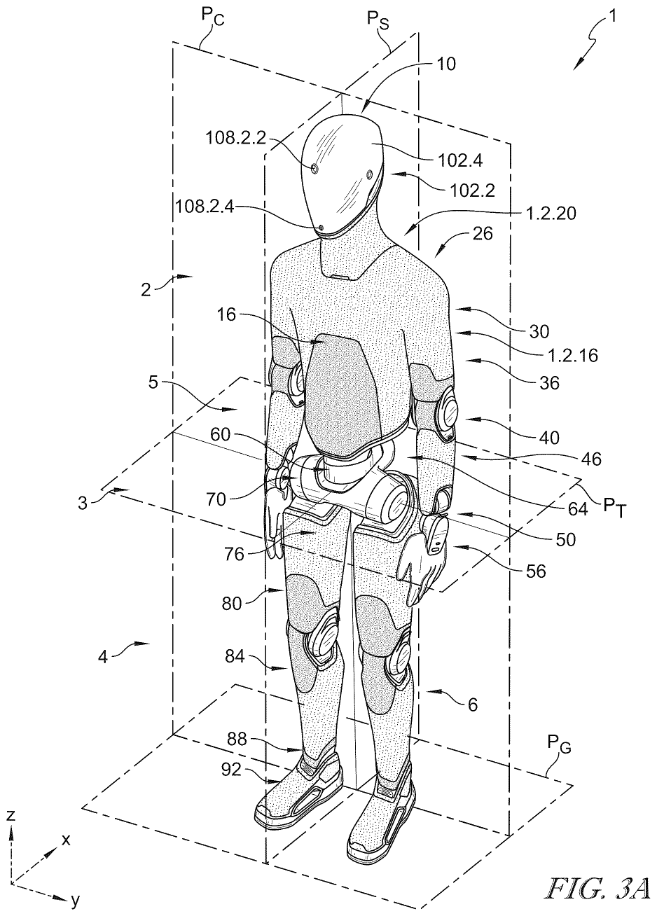

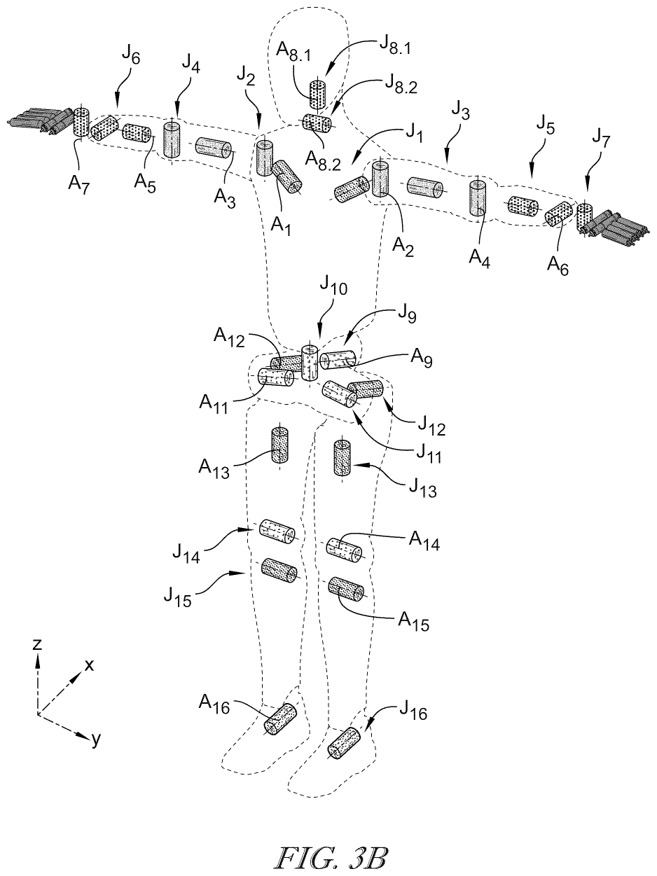

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

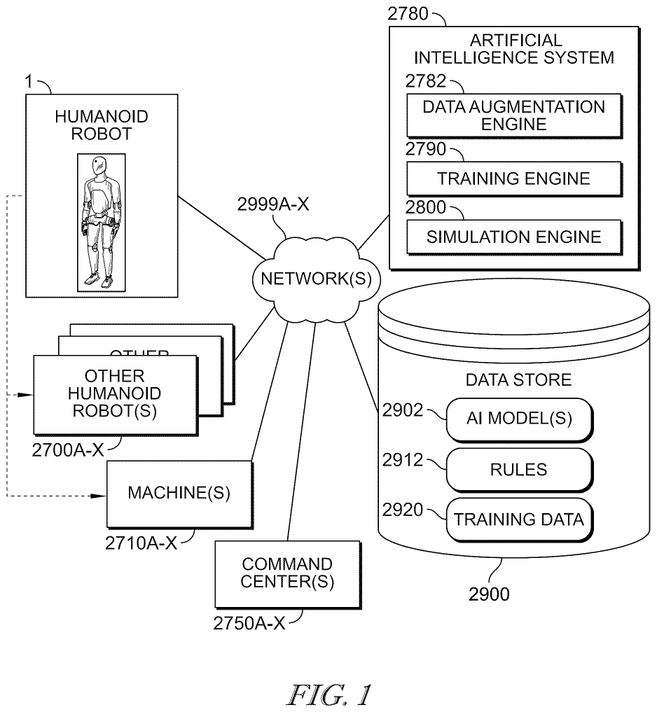

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

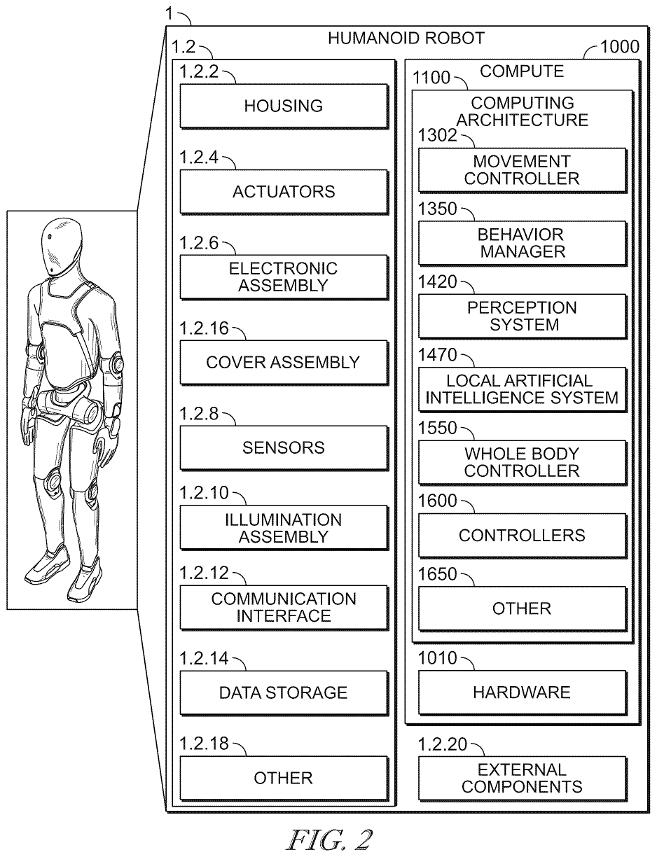

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6. In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

i. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (Pc) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

ii. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

iii. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

iv. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the table below.

TABLE 1

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm | upper arm x, upper arm roll | A₃ |
| | | twist | | |
| (J4) 374 | 2 | elbow | arm z, arm yaw, | A₄ |
| | | | lower humerus | |
| (J5) 468 | 2 | lower arm | lower arm x, lower arm roll | A₅ |
| | | twist | | |
| (J6) 484 | 2 | wrist flex | wrist/hand y, wrist/hand | A₆ |
| | | | pitch, flick | |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts.

ii. Sensors

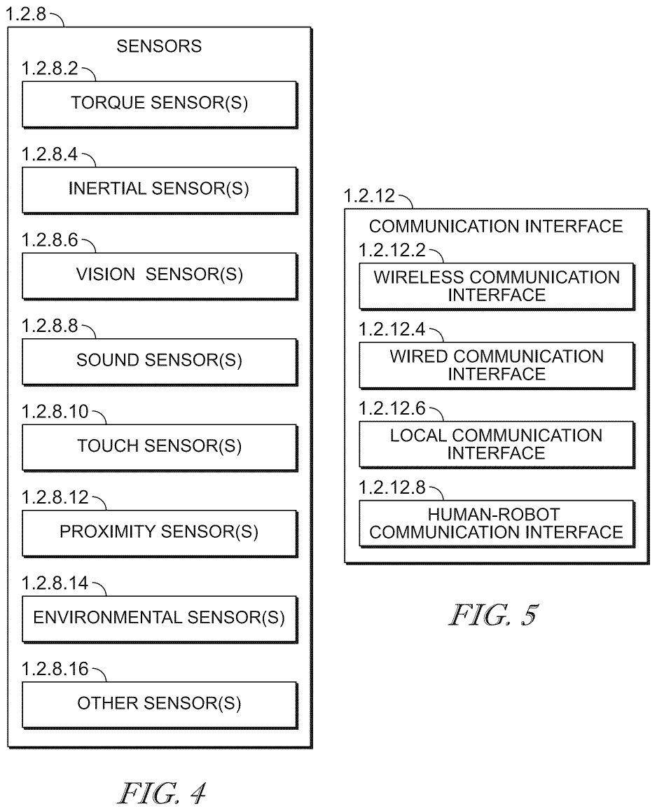

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iii. Communication Interfaces

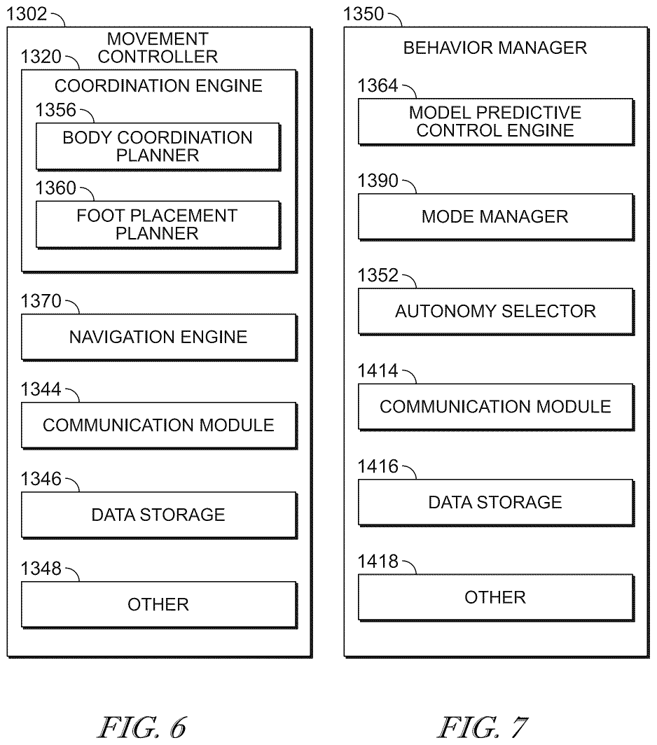

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

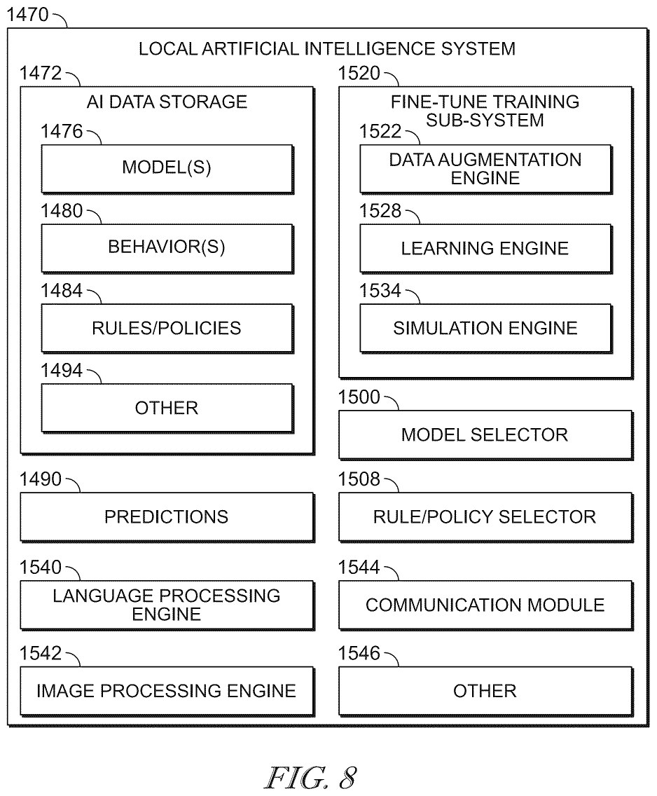

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

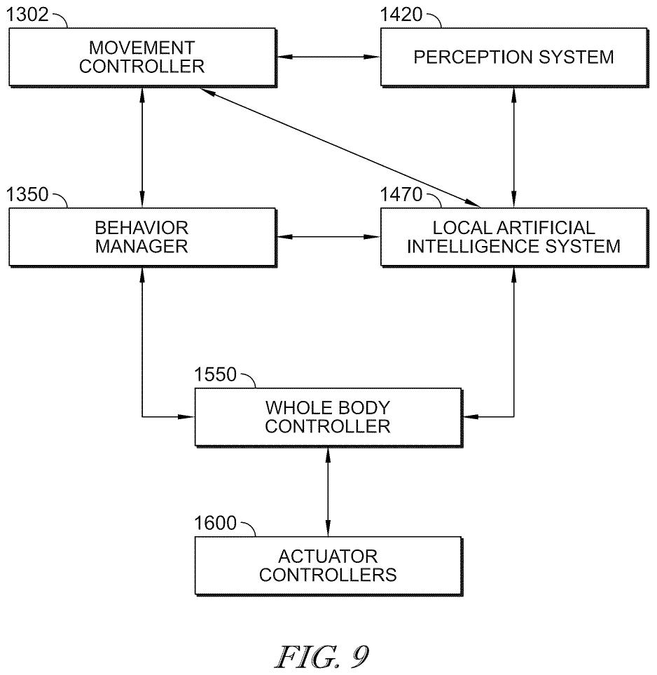

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

4. Local AI system

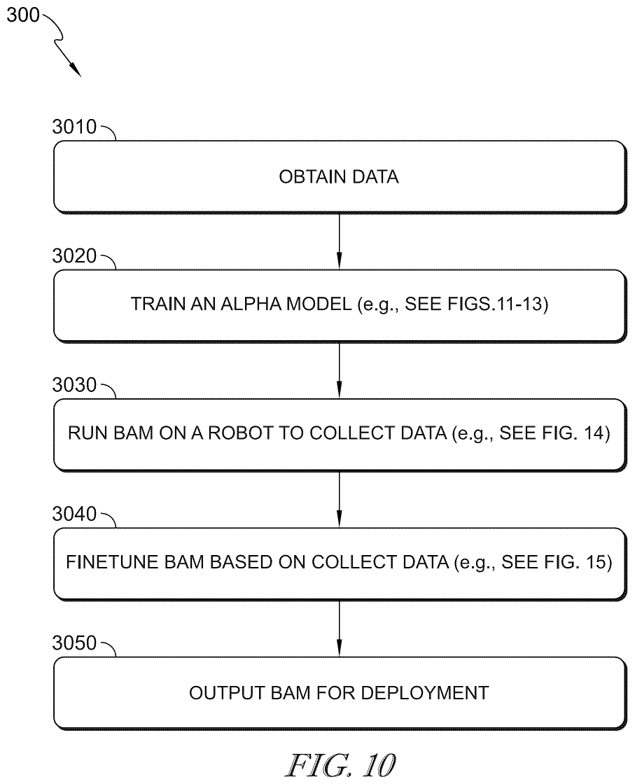

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including visual, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

d. Interaction Between Components of the Computing Architecture

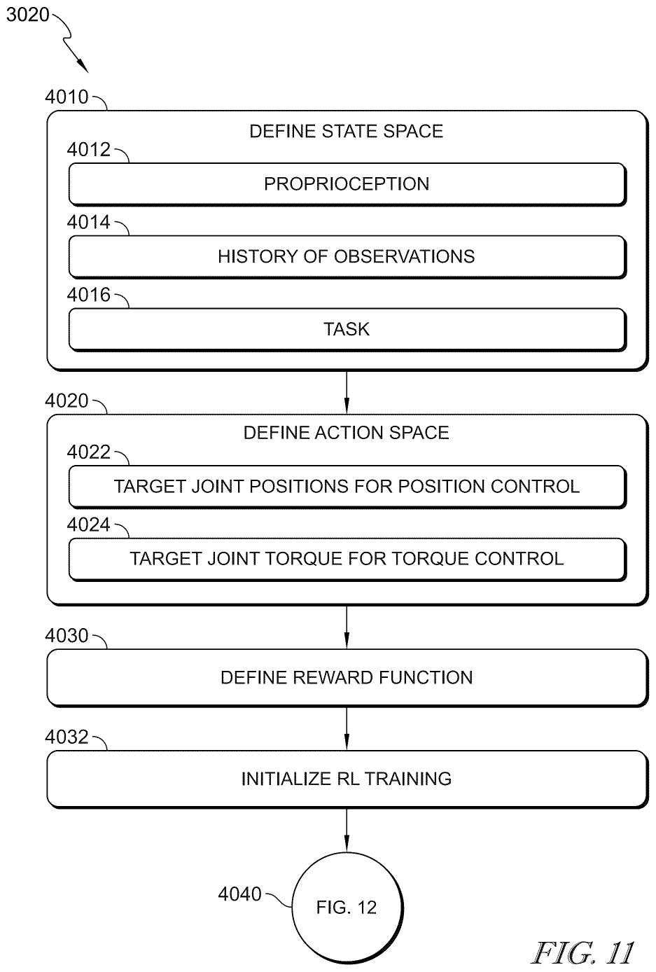

FIG. 9 depicts interactions between components of the humanoid robot 1 during its operation. Upon startup of the humanoid robot 1, the humanoid robot 1 may be in a standby mode or may otherwise remain idle in an initial position (e.g., standing, sitting, lying down, etc.). The robot 1 may initialize and activate its sensors 1.2.8 and obtain data in relation to the environment and surroundings of the robot 1, as well as positional data, audiovisual data, and the like. The movement controller 1302 may be configured to obtain data from its environment using the perception system 1420, while understanding the location and position of the robot 1 within said environment.

As described above, the environmental data and the robot data can be fed into: (i) the BAM, wherein a portion of said BAM (e.g., the beta model 3001.2) is running on the local AI system 1470, and (ii) the behavior manager 1350. The BAM can then convert speech to text in order to obtain long-horizon goals, wherein said BAM can subdivide these long-horizon goals into one or more sub-goals or tasks. The BAM can then check with the behavior manager 1350 to confirm that the robot 1 is in the correct state for performing the first sub-goal or task. Once the state of the robot 1 is confirmed or the state of the robot 1 is changed to be in the right state, the BAM can determine the movements and actions to perform for a given specified task. For instance, the alpha model 3001.1 of the BAM may process the task and sensor data to generate information that is provided to a semantic latent vector. This information is passed through said latent vector and into the beta model 3001.2 of the BAM. The beta model 3001.2 of the BAM may then communicate the detailed movement or action information to the whole body controller 1550, which in turn generates joint current data and/or torque data and transmits the data to the controllers 1600 to effect activity in the actuators 1.2.4 and cause the movement or action to be performed.

Each of the interacting components may provide feedback information to each other as the movements or actions are being performed. For example, the perception system 1420 may relay an indication to the movement controller 1302 that a given task is complete based on audiovisual data received during the performance of an action or movement. As another example, the behavior manager 1350 may be in continuous communication with the whole body controller 1550 to ensure that the movement and positioning of the robot 1 are as instructed and/or planned by the local AI system 1470. As yet another example, the local AI system 1470 may continuously receive data from the perception system 1420, the movement controller 1302, the behavior manager 1350, and the whole body controller 1550 and use the data to refine and optimize the currently executing model given present configurations, conditions, and constraints. It should be understood that the movement controller 1302, behavior manager 1350, perception system 1420, whole body controller 1550, and/or controllers 1600 may be omitted or replaced in alternative embodiments.

### E. Training Bipedal Action Model

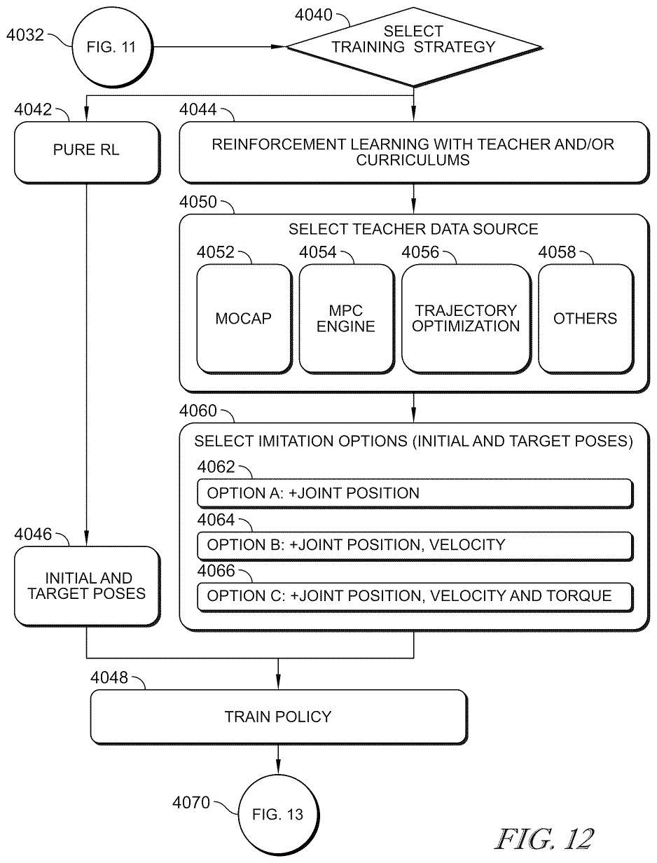

FIG. 10 is a flowchart of a process 3000 for training a bipedal action model (BAM) with reinforcement learning (RL) techniques. Although the disclosed technology is described with reference to training a BAM, other types of models for controlling the humanoid robot 1 may be generated, trained, and deployed as described herein.

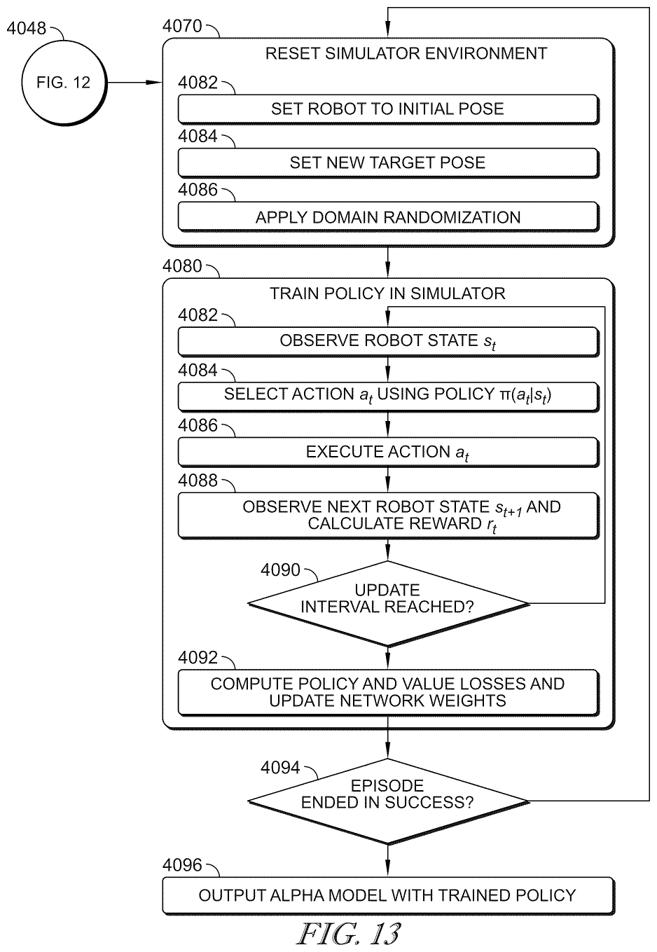

At block 3010, training data may be obtained, for example, by the remote AI system 2780. At block 3020, one or more Alpha models of a BAM may be trained using the training data and RL techniques. This first level of training can be performed offline at the remote AI system 2780, or another computing system that is remote from the robot 1 (e.g., refer to block 3020 of FIGS. 11-13 for further discussion about training the Alpha models). The system 2780 can then transmit one or more trained Alpha models as part of the BAM to the computing architecture 1000 of the robot 1 for further training and deployment.

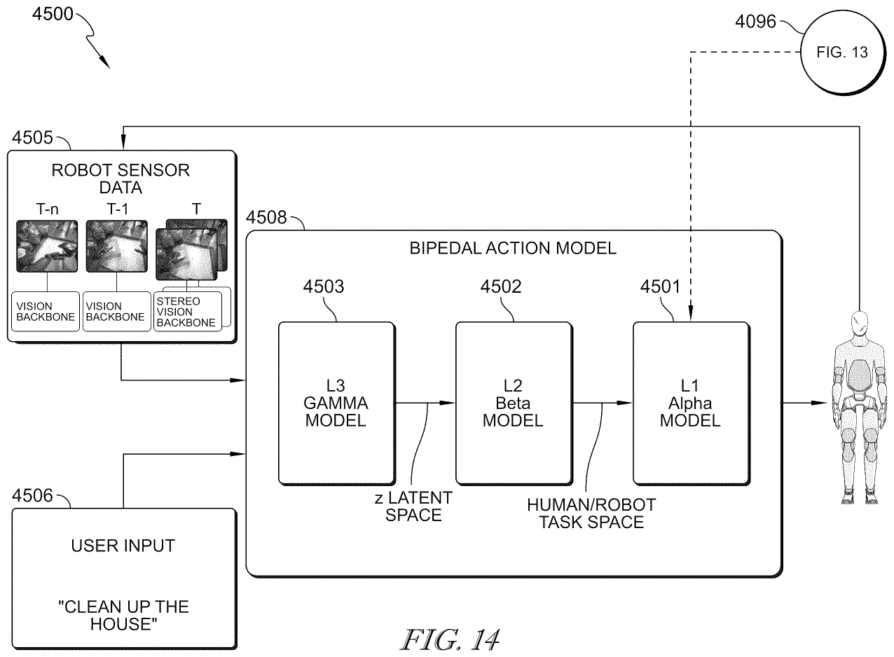

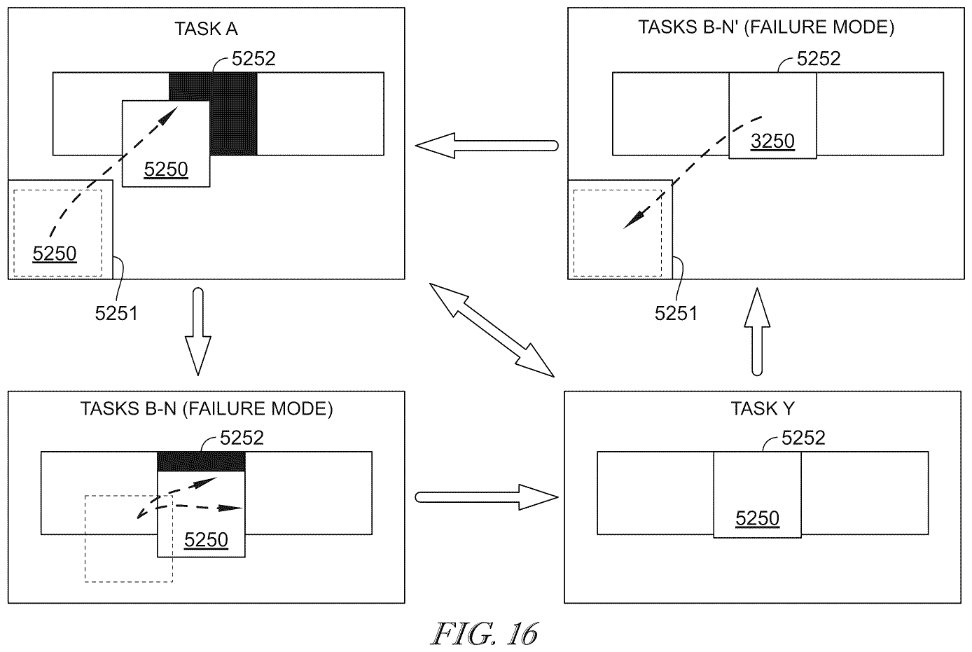

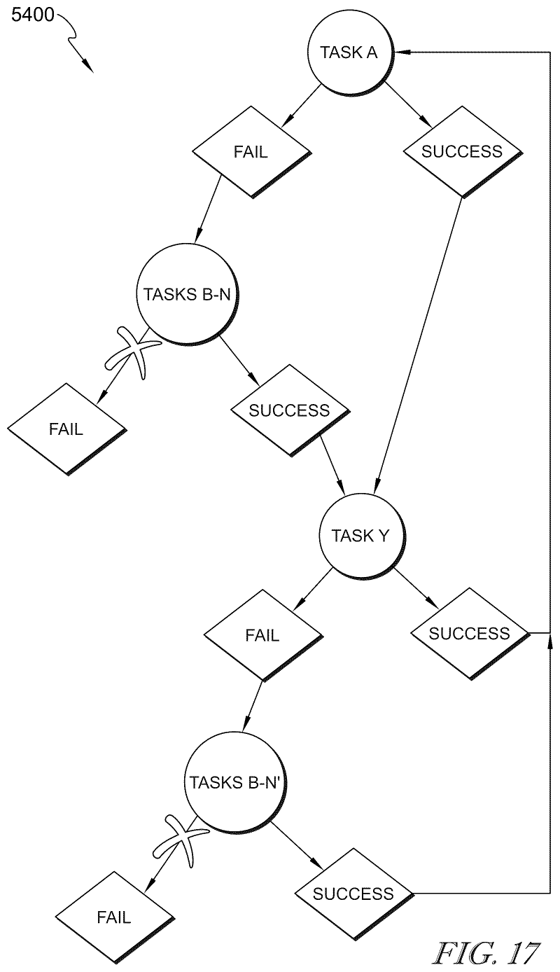

At block 3030, the BAM may be run on a robot to collect data. This online and on-the-edge process at the robot 1 may involve the computing architecture 1000 providing instructions for the robot 1 to perform an initial task, such as task A. Task A can be any type of task, which may be provided as a natural language spoken prompt to the robot 1 (e.g., refer to at least FIG. 14 for an illustrative example of a BAM deployment). The computing architecture 1000 can apply the BAM to determine controls for completing a task A, and the controls can then be executed to cause the robot 1 to perform actions to complete the task A. A first dataset, dataset A, can be generated with data collected while the robot 1 performs the actions to complete task A. The collected data can include signals generated by the sensors 1.2.8 (as described in at least FIG. 4) or other sensors on the robot 1 or in the environment, including but not limited to cameras. Data collection may continue, for example, by collecting data for dataset B based on the robot 1 failing to complete task A and therefore self-correcting to perform a second task, task B. (Refer to FIG. 16 for an illustrative example of task B). Further data may be collected, such as data for dataset N, based on the robot 1 failing to complete task B and therefore self-correcting to perform task N. In this manner, data can be collected for every self-correcting task that is performed by the robot 1 until the robot 1 completes the original task A (e.g., refer to FIG. 16 for an illustrative example of task N and to FIG. 17 for an illustrative example of decisions made by the robot 1 to complete the original task A).

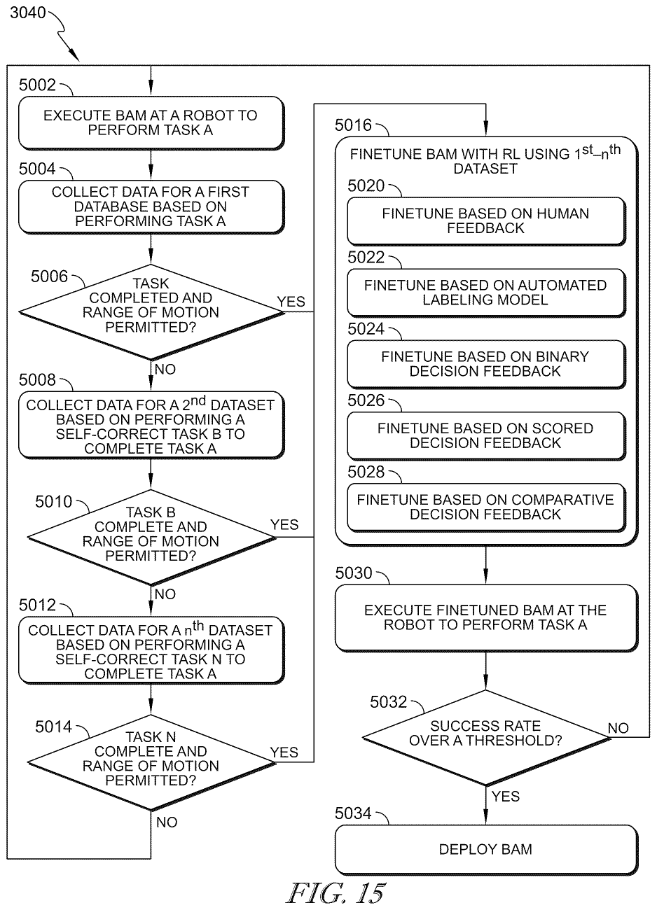

At block 3040, the BAM may be finetuned based on the collected data, such as datasets A-N. The computing architecture 1000 can finetune the BAM based on these datasets. In some implementations, the computing architecture 1000 can transmit the datasets A-N, or portions thereof, to an offline or remote system, such as the remote AI system 2780, to finetune the BAM (e.g., refer to the discussion of block 3040 in FIG. 15, for further discussion about finetuning the BAM). This process may be iterative, with the computing architecture 1000 continuing to run the BAM to collect data (block 3030) and finetune the BAM (block 3040) until a threshold level of accuracy is met. In other words, the BAM can be continuously trained and improved upon until the robot 1 accurately completes task A. The threshold level of accuracy may be met, for example, once the robot 1 completes task A without having to self-correct and consequently perform any quantity of tasks (or sub-tasks) B-N. This second level of training, or finetuning, can be performed online at the computing architecture 1000 of the robot 1, allowing the BAM training to be completed on the edge. This approach allows for efficient and continuous improvements of the BAM to dynamically adapt and self-correct tasks or other actions that are performed by the robot 1 in real-time.

At block 3050, once the threshold level of accuracy is met for the BAM, the computing architecture 1000 can output the BAM for deployment and runtime use. Outputting the BAM can include maintaining the BAM in memory at the robot 1 and/or in the AI data store 1472 of the onboard artificial intelligence system 1470 (e.g., refer to FIG. 8). Outputting the BAM can also include transmitting the BAM to one or more other humanoid robots for deployment and runtime use. As a result, the BAM can be trained online at one robot and then deployed across a plurality or group of robots operating in an environment (e.g., the same environment, such as a warehouse or factory, or different environments).

a. Offline Training of Alpha Model

Referring to block 3020 in the process 3000 of FIG. 10, an Alpha model may be trained for controlling the robot 1 utilizing offline reinforcement learning techniques. This offline training process may be configured to enable the model to not only follow diverse commands for performing locomotion, manipulation, and combined loco-manipulation tasks, but also to concurrently maintain balance, remain dynamically stable across varied conditions, and ensure all joint movements remain within their designated ranges of motion. Once converged, this Alpha model may function as a reactive, versatile, and general-purpose motion controller for the robot 1. The utility of such an Alpha model may extend beyond a singular application, such as within a teleoperation controller, and may instead enable a wide range of control paradigms and flexible deployment models. As an illustrative example, the Alpha model may be integrated into the whole-body controller (WBC) 1550, where it can serve as a universal motion generation module. This integrated system may be configured to accept commands from a diverse array of input devices, allowing for flexible human-in-the-loop operation. For direct human control, these input devices may include, for example, a wearable teleoperation apparatus, a handheld device such as a joystick, or a game controller. The Alpha model, as a result of its training, may be capable of interpreting different command modalities. Such modalities may include target end-effector poses received from the wearable teleoperation apparatus or target velocities originating from the joystick. The model can then translate these varied inputs into dynamically stable, full-body motions for the robot 1, adhering to the stability and joint-limit constraints learned during its offline training. Furthermore, the Alpha model may also be integrated with an advanced cognitive AI architecture, such as the bipedal action model (BAM) discussed herein. This integration may provide the foundational motion control upon which the cognitive architecture operates, thereby allowing the robot 1 to execute complex, autonomous behaviors.

The training of the RL policy of the Alpha model is a structured, multi-stage process designed to develop a robust and intelligent mapping from sparse operator commands (see e.g., block 4020 in FIG. 11) and robot sensory data (see e.g., block 4010 in FIG. 11) to full-body, dynamically stable actions. This process leverages a simulated environment to allow the policy to learn through thousands to millions of trial-and-error interactions, a volume that would be impractical and potentially unsafe to perform on a physical robot. The overall methodology involves defining the learning problem, selecting an appropriate training strategy, and executing an iterative training loop until the policy converges to a high level of performance. This learned Alpha model can then be deployed to the physical robot as the lowest layer of the BAM, enabling intuitive and effective robot control. The following sections provide a detailed description of this training process, as illustrated in the flowcharts of FIGS. 11-13.

i. Initialization of the RL Environment

The initialization phase (as shown in FIG. 11) can establish the foundational components of the RL training problem.

Importing a robot into a simulator for offline training can be an initial step, as it defines the environment in which the agent (e.g., the simulated robot 1) will learn and the specific goals it will be optimized to achieve. The process begins with defining the digital representation of the robot and its environment. The system may also generate a digital model of the humanoid robot, along with the environment and/or the interactions between the environment and the robot. To accomplish this, the system may use a commercially available or custom or simulation tool, wherein said commercially available tool may be MuJoCo, PyBullet, Unity (with physics engines like PhysX), Gazebo, or other similar tools. Said modeling of the robot typically involves careful modeling of at least the humanoid robot's: (i) geometry, (ii) mass distribution, (iii) moments of inertia, (iv) joints, (v) actuators, (vi) how it interacts with contacts and forces, and/or (vii) any other known or useful parameter of a humanoid robot. In particular, modeling of the moments of inertia (which may be in a format like URDF (Unified Robot Description Format)) helps ensure that the humanoid robot's movements—such as how fast an arm swings or how a robot balances—match the physical humanoid robot. Also, modeling the joints may include modeling the robot's: (i) degrees of freedom, (ii) range limits, (iii) stiffness, damping and/or friction. Further, modeling the actuators may include modeling: (i) maximum torque/force outputs, (ii) continuous torque/force outputs, (iii) acceleration and/or velocity limits, and (iv) control response delays. Said modeling of actuators may include: (a) a control loop (like a PID controller) that takes a target (position or velocity) and applies forces, simulating the closed-loop behavior of real servo motors, (b) motor inertia, (c) gear ratios, (d) electrical limits, (e) thermal limits, and/or (f) torque-speed curves.

To construct a digital representation of a humanoid robot, the system may generate a multi-body model comprising a skeleton of articulated rigid bodies-referred to as links interconnected by joints, forming a kinematic chain. This structural representation, which may be similar to character rigging in computer animation, enables the definition of joint constraints and mobility, including revolute, prismatic, or more complex joint types. The system may employ analytical or numerical techniques to derive the manipulator Jacobian matrix, which encodes the differential relationship between joint velocities and end-effector velocities, and can help in solving inverse kinematics problems and in implementing velocity-based control schemes.

Beyond purely kinematic modeling, dynamic modeling may be employed to capture the relationship between forces and torques acting upon the robot and the resulting accelerations and motions. Given that a humanoid robot constitutes a highly complex, articulated rigid-body system-comprising multiple interconnected links, each characterized by distinct mass properties, spatial inertia tensors, and nonlinear orientation-dependent dynamics—the accurate modeling of its motion necessitates a comprehensive dynamic formulation. Each joint may introduce both kinematic degrees of freedom and potential holonomic or non-holonomic constraints, which may be rigorously accounted for in the system's equations of motion. To help ensure computational efficiency, advanced recursive algorithms are employed. The Recursive Newton-Euler Algorithm (RNEA) is utilized for the computation of inverse dynamics, determining the joint torques required to achieve a specified motion trajectory. Conversely, the Articulated Body Algorithm (ABA) facilitates the computation of forward dynamics, resolving joint accelerations resulting from known torque inputs. Both algorithms exploit the tree-structured topology of the robot and the sparsity of the system's dynamic matrices to achieve linear computational complexity, O(n), with respect to the number of degrees of freedom n. Other algorithms or frameworks that may be used include composite rigid body algorithm (CRBA), Featherstone's Spatial Algebra framework, constraint-based formulations such as Lagrange multipliers or augmented Lagrangian methods, numerical integrators such as variational integrators and Lie group integrators, and/or any other known algorithm.

To improve the realism and safety of interaction, compliance modeling may be incorporated into the joint dynamics. This can involve augmenting the rigid joint model with viscoelastic elements-typically represented as series spring-damper systems-thereby allowing limited deformation under load. Compliance can also be designed at both the actuator level, such as in Series Elastic Actuators (SEAs), and at the structural level, such as flexible footpads or linkages. These compliant components can be modeled by superimposing rotational or translational spring-damper elements on the joint torques, yielding more accurate representations of impact behaviors, such as ankle flexion during foot strike. This forms the basis for impedance control strategies, wherein the robot is commanded to emulate the dynamics of a target mass-spring-damper system, enabling stable interaction with uncertain or dynamic environments.

In addition to generating a digital model of the humanoid robot, the system may also generate models of the environment and/or the interactions between the environment and the robot. For example, the system may model ground friction and other contact friction that may affect the robot's locomotion, grip, and stability. In particular, said system may implement a friction model (e.g., Coulomb friction with static and kinetic coefficients, Stribeck friction model, Dahl or LuGre friction models) for the contact between the robot's feet and the ground, wherein said model may include both static friction, dynamic friction, and/or hybrid frictions that can account for other scenarios. Further, said system may also model joint stiffness, damping and/or friction (e.g., associated with said gearboxes).

Said model of the environment and/or the interactions between the environment and the robot may include modeling diverse conditions—flat lab floors, concrete, carpet, grass, sand, rocky ground, or inclined planes, uneven outdoor terrain, slopes, and/or under external perturbations. Each surface can be characterized in simulation by properties such as friction coefficient, stiffness (compliance), elastic modulus, damping coefficient, geometry irregularities, combinations thereof, and/or any other property. Varying terrain friction may be useful to help ensure that the disclosed humanoid robot can handle walking on smooth flooring uneven terrain, and/or wet/low friction surfaces.

In addition to modeling surfaces, the model of the environment and/or the interactions between the environment and the robot may further include other environmental forces. Said forces may include wind or lateral loads or forces (e.g., push from a 3rd person or object), or shifting payloads (e.g., carrying a box, whose weight shifts as the robot walks). For instance, a wind disturbance can be modeled as a lateral force that varies over time, and the system can test whether the robot's control system can maintain course or balance under these disturbances. Further, said system may include a collision handler, which is designed help govern how the humanoid robot interacts with objects, obstacles, and its own body parts. Said collision handler may include two aspects, wherein the first relates to collision detection (finding when and where two geometries contact), and the second relates to collision response (computing forces resulting from the contact, such as normal force and bounce). The collision handler may use either a penalty method or constraint-based solvers to attempt to accurately model the robot's physical configuration, mass, and associated material properties (e.g., bounciness and/or stiffness).

The system may include a range of optimization strategies to achieve the desired performance without sacrificing the fidelity for meaningful results. These strategies may involve tuning simulation parameters, leveraging hardware acceleration, and validating the simulation against real-world performance. For example, the system may reduce the update frequency (from 10 Hz to 10,000 Hz) to improve the simulation speed, reduce the number of iterations per step, utilizing primitive shapes (e.g., spheres, boxes, cylinders) or convex hulls for modeling objects that may contact the robot, use a varying level-of-detail (LOD) technique, leveraging modern hardware acceleration and/or a combination of the same.

The implementation of these techniques should be considered in light of their impact on simulation accuracy. As such, the system may use validation and verification (V&V) techniques, which may involve comparing simulated outcomes against real-world benchmarks using standardized, repeatable test scenarios. For example, V&V may begin with parameter tuning based on empirical measurements taken directly from the physical humanoid robot and its operating environment. Key physical properties such as mass, inertia, joint damping, actuator dynamics, and surface friction may be quantified through controlled experiments—for example, using swing tests to determine limb inertia, dragging the robot across a surface to assess friction coefficients, or measuring motor response curves. These values may be used to calibrate corresponding simulation parameters. Simplified validation scenarios, such as single-joint movements or linear traversals, provide benchmarks for comparing simulated and real-world behaviors, including distance traveled, oscillatory response, overshoot, and energy usage. Overfitting the simulation to a single scenario may lead to reduced generalizability. Therefore, cross-validation across multiple conditions—such as varying terrain inclinations and step navigation—can be employed to ensure robustness and parameter consistency.

The system may also incorporate uncertainty and sensor or actuator noise into the simulation environment. This recognizes the inevitable discrepancies between real and virtual systems, such as mechanical tolerances, control lag, or environmental variability. Domain randomization techniques, which introduce stochastic variations to key parameters (e.g., mass, friction, sensor fidelity), may be used. This may also include validating the simulator's behavior against known physical systems—e.g., verifying pendulum dynamics against analytical models or checking free-fall behavior for conformity with classical mechanics equations. Kinematic accuracy, energy conservation in frictionless systems, and consistency of joint-angle-based pose estimation may also be validated, particularly when using custom simulation components or plugins. In other embodiments, physically based retargeting, momentum preservation, contact force adjustment, and drag and buoyancy simulation may be implemented.

### 1. Define State Space

Following the definition of the simulator, the state space is defined (as shown in block 4010). The state space, also referred to as the observation space, defines all the information that the RL policy of the Alpha model receives at each timestep to make a decision, corresponding to the robot states (see block 4010) and commands (see block 4020) in FIG. 11. A well-designed state space provides the policy with a comprehensive understanding of its own configuration and the operator's intent. This may include robot proprioception data (as shown in block 4012), which is the robot's sense of its own body, including the current joint position and joint velocity of all its motors, as well as data from IMUs, such as the base velocity and the projected gravity vector. The state space may also include a history of recent observations (as shown in block 4014), which constitutes history data, to provide the policy with a sense of temporal context and motion dynamics, allowing it to infer velocities and accelerations. Furthermore, the state space includes the task command (as shown in block 4016), which represents the operator's goal and may include the sparse target pose provided by the user.

### 2. Define Action Space

Next, the action space is defined (as shown in block 4020), which specifies the set of possible outputs the policy can generate, corresponding to an action. For continuous control of a humanoid robot, the action may be a vector of numerical values. One option is for the policy to output target joint positions for position control (as shown in block 4022). In this approach, the policy outputs a target angle for each joint, which is then sent to low-level controllers, such as proportional-derivative (PD) controllers, that compute the angle shift. Another option is for the policy to output target joint torque for direct torque control (as shown in block 4024), which gives the policy direct control of the target motor currents. In further embodiments, the policy may output impedance control parameters (e.g., stiffness and damping), force command along with a position/velocity command, and/or any combination thereof.

### 3. Reward Function

In accordance with the present disclosure, a reward function can be defined, as shown in block 4030, to provide a feedback signal to a learning agent. This reward function implicitly defines an operational task and shapes the agent's behavior toward a desired outcome. The generation of the reward function is a significant design choice that involves specifying not just the objectives, but also their form and interaction. The function may be configured as a complex composite of multiple objectives, and its structure may be modified to control for factors such as risk sensitivity, temporal abstraction, and adaptability to the environment. For instance, the reward function can be designed to guide a policy toward generating motions for a robotic system that are successful at a task level while also being physically plausible, stable, and safe.

In some embodiments, the reward function may include a primary task-success objective. To ensure physical stability and safety, the function may further incorporate stability objectives, such as a substantial negative penalty applied in response to a detected failure event. The specification of such objectives can be made more rigorous using formal verification methods, such as defining safety constraints and success conditions using temporal logic (e.g., LTL or CTL), which allows for unambiguous definitions of complex, time-dependent behaviors. To promote higher-fidelity motion, the function may include efficiency and regularization objectives, such as penalties on high joint torques or high acceleration. The relative weighting and scaling of these components may be dynamically adjusted based on the operational context or agent's state, and reward normalization techniques may be applied to prevent certain objectives from dominating the learning process due to differences in magnitude. Furthermore, potential-based reward shaping may be employed to guide exploration without altering the underlying optimal policy. The function can also be modified to be risk-sensitive by penalizing high variance in outcomes, or to be uncertainty-aware by rewarding actions that reduce the agent's uncertainty about its model of the environment. To address the challenge of sparse rewards, which define a clear goal but can hinder exploration, techniques such as Hindsight Experience Replay (HER) may be utilized. HER reframes failed trajectories as successful attempts at achieving different, unintended goals, thereby creating a denser and more informative learning signal. The learning process can be further enhanced by introducing auxiliary tasks, wherein the agent is rewarded for accomplishing self-supervised objectives, such as predicting future states, which encourages the development of more robust state representations.

In other embodiments, the reward function may be configured to incorporate imitation and demonstration-based objectives. Such objectives may reward the policy for closely tracing state or action profiles derived from a reference motion, which may be provided by an expert demonstration or a motion planning system like a model predictive control (MPC) engine. An alternative imitation-based approach involves adversarial learning, wherein a discriminator is trained to distinguish between agent-generated motions and expert demonstrations. The reward signal for the agent is then derived from its ability to generate motions that are statistically indistinguishable to the discriminator. In further embodiments, the reward function itself may be learned from data. One such method is inverse reinforcement learning (IRL), wherein an algorithm infers the underlying reward function from a set of expert demonstrations. Alternatively, the reward function can be learned through preference-based methods, wherein a reward model is trained to predict human preferences between pairs of trajectory rollouts.

To address tasks requiring long-horizon reasoning, the reward function can be structured according to a hierarchical reinforcement learning (HRL) paradigm. In this approach, the control problem is decomposed into multiple levels of abstraction. A Gamma model is trained with a reward function that incentivizes the selection of a sequence of sub-goals or abstract tasks. Concurrently, one or more low-level policies are trained with separate reward functions designed to incentivize the successful execution of the specific sub-goals provided by the Gamma model. This decomposition allows the agent to learn complex behaviors more efficiently by operating over different temporal scales. In yet other embodiments involving multi-agent systems, the reward function for a given agent may be dependent on the actions or states of other agents. The structure of the reward can be designed to induce different multi-agent behaviors, such as cooperative (e.g., all agents share a global team reward), competitive (e.g., one agent's gain is another's loss, as in a zero-sum game), or mixed-motive scenarios. Furthermore, the reward function may need to be non-stationary, adapting over time in response to changes in the environment or the evolving policies of other learning agents, a key consideration in continual or lifelong learning settings. Finally, the system may employ a multi-objective optimization approach as an alternative to collapsing all objectives into a single weighted sum. The objectives can be treated as a vector of rewards, and the learning process aims to find a set of policies representing the optimal trade-offs, or Pareto front, between these competing objectives. An operator may then select a policy from this set that is best suited to a specific context.

Additionally and/or alternatively, the reward function may include the following components or combinations of the following components: joint accuracy, smoothness, momentum, balance, energy efficiency, imitation reward, footstep reward, task-specific objectives, stability, posture control, step symmetry, contact consistency, impact force minimization, trajectory tracking, velocity matching, heading alignment, center-of-mass control, torque minimization, ground reaction force matching, gait cycle timing, fall avoidance, slippage reduction, actuator usage penalty, directional locomotion reward, foot clearance, swing leg timing, double support phase control, step length consistency, arm-leg coordination, terrain adaptability, obstacle avoidance, recovery behavior reward, turning efficiency, body orientation control, step frequency control, sensory feedback alignment, muscle activation regularization, joint limit avoidance, penalization of over-extension, joint coordination, redundancy minimization, biomechanical plausibility, contact force regularity, footstep placement accuracy, delayed reward shaping, learning progress bonus, novelty bonus, goal proximity reward.

The following reward function may include at least the following components (e.g., joint accuracy, smoothness, momentum, balance, and energy).

$${R}_{t} = {w}_{1} {R}_{j o i n t} + {w}_{2} {R}_{s m o o t h} + {w}_{3} {R}_{m o m e n t u m} + {w}_{4} {R}_{b a l a n c e} + {w}_{5} {R}_{energy}$$

However, it should be understood that this additional detail regarding these components is not limiting and instead is only designed to provide greater detail in connection with a few of the many components that are contained in the reward function.
a. Joint Positional Accuracy

This component is designed to encourage the robot to match physics-based simulation of the humanoid robot at each timestep. This can be achieved by penalizing differences in joint angles or positions between the simulated robot and the reference motion. An example of this component is shown below, where it can be implemented for N joints with the robot's joint angle being θ_{robot,j} and the joint angle of the physics-based simulation of the humanoid robot being θ_{ref,j}.

$${R}_{p o s e} = \frac{1}{N} {\sum }_{j = 1}^{N} {( {θ}_{robot , j} - {θ}_{ref , j} )}^{2}$$

Additionally, this component may use mean squared error (MSE) between corresponding joint angles of the robot and reference. This may be implemented as: rewardₚₒₛₑ=e^{-α·R}^{ₚₒₛₑ}, where alpha is a scaling factor to shape the reward (using an exponential transforms error into a bounded [0,1] reward). The use of an exponential or cosine ensures the reward is highest when angles align perfectly and drops off as misalignment grows. This term alone drives the policy to put the robot's limbs in the right configuration at the right time, matching keyframes of the animation. In alternative embodiments, a cosine function may be used for rotational data, treating each joint's orientation or axis-angle as a vector and computing the normalized dot product between simulated and reference orientations.

b. Angular Velocity Consistency

This component is designed to help ensure the robot's movements are not only pose-accurate but also fluid and realistic, matching the timing and speed of the physics-based simulation of the humanoid robot. This term rewards the agent for reproducing the joint angular velocities observed in the reference. It penalizes abrupt or jerky motions that deviate from the reference's smooth velocity profile. An example of this component is shown below, where it can be implemented for J joint with the robot's angular velocity is ω_{robot,j} and the angular velocity of the physics-based simulation of the humanoid robot is ω_{ref,j}.

$${R}_{v e l} = \frac{1}{N} {\sum }_{j = 1}^{N} {( {ω}_{r o b o t , j} - {ω}_{r e f , j} )}^{2}$$

This component may be implemented by taking the difference of local joint angular velocities (with reference velocities computed via finite differences from motion capture data) and rewarding the agent when this difference is small. Another approach is to penalize high-frequency changes in joint angles (i.e. large accelerations or jerk), indirectly encouraging smooth motion. In a further or additional example, the component may compute the velocity error for each joint and may further be implemented as: rewardvel=e^{-β·}^{_{Rvel}}, where β is a scaling factor. This term gives the agent positive feedback for moving its joints at the correct speeds. By combining positional and velocity rewards, we force the policy to not just “hit the right poses,” but to do so with correct timing. This greatly reduces jittery behaviors; without a velocity term, an agent might rapidly oscillate around the correct pose to maximize the pose reward each instant, resulting in unnatural motion. The velocity consistency reward aligns the motion's tempo with the reference, yielding fluid transitions (i.e. preventing jerky movements) and more life-like imitation.

c. Momentum Management

This component is designed to impose physical momentum conservation principles so that the robot's dynamics (inertia, momentum, and forces) resemble those of the reference motion. This prevents the agent from exploiting physics in unrealistic ways (e.g. rapidly changing direction or speed without appropriate forces) and ensures dynamic consistency with the reference. In human motion, momentum changes are gradual and follow from forces like foot-ground contact; the agent should exhibit the same pattern. One way to incorporate momentum is to compare the robot's centroidal momentum (total momentum of the system) with that of the reference. The centroidal linear momentum is total mass times center-of-mass velocity, and centroidal angular momentum can be computed about the center-of-mass. A reward term can penalize the difference in these quantities:

$${R}_{m o m} = ( {‖ {p}_{s i m} - {p}_{r e f} ‖}^{2} + λ {‖ {L}_{s i m} - {L}_{ref} ‖}^{2} )$$

where λ weights the angular momentum penalty relative to linear momentum. If the reference motion conserves angular momentum during a spin or jump, the agent is encouraged to do the same and not, say, generate excess rotation without cause. In practice, ensuring momentum consistency often overlaps with velocity and center-of-mass tracking terms, but explicitly penalizing momentum errors can further refine dynamic realism. By adding a momentum term, we discourage the agent from sudden changes in velocity that would imply unrealistic impulses or external forces.

The environment can calculate the robot's center-of-mass velocity (from the physics engine) and total angular momentum each step, and compare them to the reference. For example: rewardₘₒₘ=e^{-δ·R}^{ₘₒₘ}. Here, compute_centroidal_angular_momentum would sum for all limbs about the CoM. As with other terms, an exponential or negative quadratic can convert the difference into a reward. This term particularly helps in dynamic motions (like a kick or jump)—the agent may move with the same “oomph” as the reference, neither too timid (low momentum) nor too erratic (excess momentum), yielding a more physically natural imitation.

d. Center-of-Mass Trajectory Alignment

This component is designed to align the robot's center-of-mass (CoM) path with that of the reference motion. The CoM trajectory captures the overall translation and balance of the character. By tracking it, we ensure the robot goes where the reference goes (e.g., if the reference leans or steps to the side, the robot does too) and maintains balance similarly. The euclidean distance between the simulated and reference CoM positions at each time step, possibly integrated over the episode. A simple formulation at time t is:

$${R}_{C o M} = - \vert {x}_{CoM , robot} ( t ) - {x}_{CoM , ref} ( t ) {\vert}^{2}$$

where x_{CoM} is the 3D CoM coordinate. Summing this over all time steps (or taking an average) would measure trajectory alignment over time. This may be done by explicitly included a term penalizing deviations in the character's CoM from the reference's CoM. This ensures that even if joint poses are individually correct, the whole-body position and balance stay on track. For example, without a CoM term, a robot could learn the right leg motions but remain in place, whereas the reference walks forward—it would get joint pose rewards but clearly fail the overall imitation. The CoM term prevents such spatial drifts by rewarding the robot for being in the same place as the reference.

For each step, compute the distance between the robot's CoM and reference CoM. Some implementations also compare CoM velocity vectors for closer dynamic alignment (which is effectively covered by the momentum term above): reward_{com}=e^{Γγ·R}^{_{CoM}}, where γ a scaling factor. This term particularly contributes to balance: if the robot's CoM strays too far (for instance, leaning forward without stepping as the reference does), the error grows and reward decreases.

e. Energy Efficiency

This component is designed to help encourage the robot to use minimal energy to perform the motion, promoting efficiency and realism. Real animals and humans tend to move in energy-efficient ways; an RL agent without this consideration might use excessive joint torques or flailing movements that achieve the pose but would be energetically costly or physically unsustainable. By rewarding lower energy consumption, we bias the policy toward more graceful and economical motions that still accomplish the imitation task. This component may be implemented such that it penalize power or torque usage. If τⱼ is the torque applied at joint j and \dot{θ}ⱼ, is the angular velocity, then instantaneous mechanical power is Pⱼ=τⱼ·\dot{θ}ⱼ. The energy cost can then be calculated as the sum of power across all joints, or use τ² as a proxy for energy (since high torques typically imply high energy). The reward term can be:

$$P = {\sum }_{j = 1}^{N} \vert {τ}_{j} \cdot {\dot{θ}}_{J} \vert {R}_{energy} = - {P}_{total}$$

which is negative of the power (so using more power incurs a larger penalty). Some implementations normalize this or use a small coefficient

$$( e . g . - κ Σ {τ}_{j}^{2} )$$

to scale the influence of energy relative to other terms. The goal is to subtract points for wasteful actuation. In a recent humanoid RL study, the reward function explicitly included energy-minimization terms, which led to natural behaviors like human-like arm swing emerging to conserve energy. By penalizing energy, the agent discovered that swinging its arms improved balance without extra effort, thus saving energy—an outcome also observed in human biomechanics.

Implementation: The environment can calculate the work done by each motor at each step. For simplicity, one might sum τⱼ or

$${τ}_{j}^{2}$$

if the sign of power is not as important as magnitude. For example: reward_{energy}=−η·P, where η is a weight scaling the impact of this term (small eta to avoid overshadowing the imitation reward). This term will give higher reward when motors exert less effort to achieve the same motion. It prevents the agent from, say, wildly swinging a limb and then counter-swinging it back into place, which might match the pose but expends a lot of energy. Instead, the agent is pushed toward smoother, lower-torque strategies—e.g., leveraging passive dynamics or momentum to move, rather than brute-force actuation. In combination with the accuracy terms above, energy efficiency helps produce motions that “feel” natural and not robotic. As a trade-off, if weighted too strongly, the agent might sacrifice motion fidelity to save energy (e.g., taking smaller steps than the reference). Thus, eta should be tuned so that the agent still prioritizes matching the reference, only trimming unnecessary effort.
f. Task Specific Components

Beyond mimicking a physics-based simulation of the humanoid robot and its environment in ideal conditions, the humanoid robot often needs to maintain performance under real-world challenges. The system can incorporate task-specific criteria into the reward to ensure the learned policy is robust, for example, by maintaining balance, handling disturbances, and adapting to environment changes. For example, the agent may be rewarded for staying upright and maintaining a stable posture. A simple survival reward can be used: e.g., +1 for every timestep the robot has not fallen over (and 0 if it falls). In another embodiment, the system may penalize large deviations in torso orientation from upright. For instance, a penalty may be applied by subtracting the squared roll and pitch angles of the torso (which should be near zero for an upright posture). Maintaining the CoM over the support base is implicitly encouraged by these terms—if the robot leans too far without stepping, it will either fall (ending the survival reward) or incur a large orientation penalty. By incorporating balance rewards, the agent may learn to subtly adjust its posture or foot placement to maintain stability, just as the reference motion would (the reference presumably being balanced as well).

To ensure the policy is robust to perturbations (like shoves or bumps), the system can introduce random external forces during training and include reward terms that measure how well the robot resists or recovers. For example, the agent may receive an additional bonus if it manages to continue the reference motion trajectory after a perturbation (without falling or deviating too much). In an example, the system may apply impulses or varying friction in the simulator and rely on the regular reward terms, along with a survival bonus. If the humanoid robot is pushed, the pose/velocity error will spike; the agent receives a higher cumulative reward by quickly reducing those errors (i.e., returning to the reference motion).

To handle different terrains, the system can train the agent on varied ground conditions (slopes, uneven surfaces, etc.) and ensure the reward encourages successful locomotion on them. To do so, the system may use domain randomization, which randomizes factors like ground friction, incline angle, or even link masses each episode. The imitation reward will naturally encourage the robot to follow the reference motion's style, but now it may do so in a range of conditions. As such, the system may include: (i) a reward term for: (a) progress (if the reference involves forward locomotion) to make sure the robot continues to move forward on a slope rather than freeze, (b) balance terms (upright posture, no falls), and/or (ii) a penalty term for: (a) stumbling (e.g. large sudden changes in CoM height or foot slip), (b) failing to maintain forward progress along the desired path (e.g., linear, curved, etc.).

Further, each reward component's weight (w1, w2, . . . ) can be tuned so that they are on comparable scales—this prevents one term from dominating or being completely ignored. For example, the raw pose term may range up to 1.0, whereas the energy penalty could be on the order of tens or hundreds of Joules; without proper scaling, the agent may solely focus on minimizing energy (if its weight times value outweighs others) and disregard pose imitation, or vice versa. In one embodiment, imitation-related terms (pose, velocity, CoM) may have higher weights in comparison to the weight of energy or robustness terms.

### 4. Reinforcement Learning Algorithm Selection

Subsequently, the RL algorithm and its associated neural networks are initialized (as shown in block 4032). The designer may select any known reinforcement learning algorithm including, but not limited to: (i) policy gradient-based algorithms (e.g., proximal policy optimization (PPO), trust region policy optimization (TRPO), vanilla policy gradient (VPG), natural policy gradient (NPG), actor-critic (AC), advantage actor-critic (A2C), asynchronous advantage actor-critic (A3C), soft actor-critic (sac), deterministic policy gradient (DPG), deep deterministic policy gradient (DDPG), twin delayed DDPG (TD3), distributed distributional DDPG (D4PG)), (ii) value-based algorithms (e.g., q-learning, deep q-network (DQN), double DQN, dueling DQN, prioritized experience replay DQN, noisy DQN, rainbow DQN, categorical DQN (c51), quantile regression DQN (QR-DQN), implicit quantile networks (IQN)), (iii) model-based algorithms (e.g., model-based policy optimization (MBPO), probabilistic ensembles with trajectory sampling (PETS), dreamer/dreamerv2, simple (simulated policy learning), muzero), (iv) evolutionary and genetic methods (e.g., neuroevolution of augmenting topologies (NEAT), covariance matrix adaptation evolution strategy (CMA-ES), genetic algorithms (GA), evolution strategies (es)), (v) imitation and inverse RL (e.g., behavioral cloning (BC), generative adversarial imitation learning (GAIL), inverse reinforcement learning (IRL), dataset aggregation (dagger)), (vi) hierarchical RL (e.g., option-critic architecture, feudal networks (FUN), hierarchical DDPG (H-DDPG)), (vii) multi-agent RL (e.g., multi-agent deep deterministic policy gradient (MADDPG), QMIX, independent Q-learning (IQL), counterfactual multi-agent policy gradients (COMA)), (viii) offline/batch RL (e.g., batch-constrained Q-learning (BCQ), conservative Q-learning (CQL), behavior-regularized actor critic (BRAC), advantage weighted regression (AWR), offline RL with implicit Q-learning (IQL), and/or (ix) any combination or hybrid of the above listed algorithms.

As described above, the reinforcement learning algorithm may utilize the proximal policy optimization (PPO) based algorithm. Said PPO algorithm is an on-policy actor-critic algorithm that uses a stochastic policy and may employ two neural networks—a policy network (actor) and a value network (critic). PPO may update the policy using clipped surrogate objectives to ensure small incremental changes, improving training stability. The network architecture may be a multi-layer perceptron (MLP) with 2-20 hidden layers (e.g., 64-2,560 units each) feeding into Gaussian action outputs for continuous control, and a parallel value estimator. PPO's on-policy nature means no replay buffer; instead, it collects fresh trajectories each iteration.

As described above, the reinforcement learning algorithm may utilize the deep deterministic policy gradient (DDPG) based algorithm. DDPG is an off-policy actor-critic algorithm for continuous actions that learns a deterministic policy (actor) and a Q-value critic. It extends DQN-style learning to continuous domains by using an actor network (s) to select actions and a critic network Q(s,a) to evaluate them. Implementation details may include a replay buffer to reuse past experiences and target networks for both actor and critic to stabilize training. DDPG injects exploration noise (e.g., Ornstein-Uhlenbeck process) into the actor's actions during training to ensure sufficient exploration. A typical network architecture uses 2-20 hidden layers (e.g., 64-2,560 units each) with ReLU activations for both actor and critic. In other embodiments, the ReLU activation functions for the actor and critic may be replaced with any one of the following functions: ReLU, Leaky ReLU, PReLU, ELU, SELU, Swish, Mish, Tanh, Sigmoid, Hard Sigmoid, Softplus, Softsign, GELU, Bent Identity, Sine, Cosine, Gaussian, Hard Tanh, Maxout, Thresholded ReLU, Cube, ArcTan, LogSigmoid, Binary Step, ReLU6, SiLU, or DSiLU.

In further embodiments, the actor and critic activation functions may not match; for instance, they may be selected independently from one another. For example, the hidden layers may be associated with a Leaky ReLU function, the actor's output layer may be associated with a Tanh function, the critic's hidden layers may be associated with ELU, while the critic's output layer may not be associated with an activation function (i.e., a linear output).The actor outputs continuous joint torques, which may or may not be bounded. Said bounding may be accomplished using any known bounding function, including tanh, sigmoid, hard tanh, softsign, softplus (with scaling), swish (with clipping), GELU (with clipping), clipping, rescaling with known limits. The critic takes state and action as input and outputs Q-values. Common training hyperparameters include a learning rate on the order of 1e-4 for both networks, a discount factor of approximately 0.99, and a polyak averaging factor (˜0.005) for target updates.

As described above, the reinforcement learning algorithm may utilize the Soft Actor-Critic (SAC) based algorithm. SAC is an off-policy actor-critic algorithm that maximizes a trade-off between reward and entropy (policy randomness). It uses a stochastic policy (typically Gaussian) and encourages exploration by adding an entropy bonus to the reward objective. Implementation-wise, SAC maintains an actor network (outputting mean and variance for each action), two Q-value critic networks (to mitigate overestimation bias, similar to TD3's twin critics), and may optionally include a value network for baseline. Many implementations drop the separate value network and compute target values directly from the twin Q estimates. SAC's networks are MLPs and may include 2 or more hidden layers of 64-2,560 neurons, and it leverages a replay buffer like DDPG/TD3. A notable feature is the automatic tuning of the entropy coefficient to adjust the exploration-exploitation balance.

As described above, the reinforcement learning algorithm may utilize the A3C (Asynchronous Advantage Actor-Critic) and A2C-based algorithm. A3C is an asynchronous policy gradient method where multiple worker threads update a global actor-critic model asynchronously. Each worker runs an environment, computes gradients for both policy and value (advantage actor-critic), and updates the global parameters periodically. A2C is a synchronous variant that waits for all workers to finish an episode or batch before updating. These methods use on-policy updates (no replay buffer). Implementation involves an actor-critic network (often a shared backbone for policy and value).

As described above, the reinforcement learning algorithm may utilize the Distributed Distributional DDPG (D4PG) based algorithm. D4PG is an advanced variant of DDPG that: (i) incorporates learning a distribution over returns (using categorical or quantile regression critics) instead of a single expected value, (ii) uses N-step returns for faster credit assignment, and (iii) runs with many parallel actor workers (e.g., 32-256) that feed experiences to a centralized learner. The architecture includes twin distributional critics and a deterministic actor. Each critic outputs a histogram or quantile distribution for the Q-value, which improves learning of noisy or multi-modal returns. A replay buffer is used, which may prioritized replay.

ii. Selection of the Training Strategy

After initialization, a decision can be made regarding the training strategy (as shown in block 4040 of FIG. 12). This choice determines how the policy will acquire its initial knowledge and be guided during the learning process. As illustrated in FIG. 12, one available option is to follow pure RL (as shown in block 4042). In this approach, the policy starts with random network weights and learns the desired behavior entirely from scratch through trial-and-error interaction with the simulated environment, guided solely by the reward function. While this method can lead to novel solutions, it is often highly sample-in-efficient. For this path, the training process may rely on a distribution of initial and target poses (as shown in block 4046) generated within the simulation to define the task for each training episode. The set of tasks defined by these poses may also be the same as those used in the imitation learning pathway (e.g., from teacher data source 4050), which may allow for a direct comparison of the training methodologies' effectiveness on an identical problem set.

A second, potentially more efficient option is to combine RL with imitation learning (as shown in block 4044). The principle of this strategy is to bootstrap the learning process with expert knowledge, addressing the significant sample inefficiency of pure RL for complex humanoid control tasks. By providing the policy with expert demonstrations, the agent's exploration is guided toward promising regions of the state-action space, which can dramatically accelerate convergence and improve training stability. This allows the RL policy of the Alpha model to acquire complex, dynamic skills that could be too time-consuming to discover through random exploration alone. The “teacher” data provides a strong motion prior, and the RL algorithm's task is transformed from one of pure discovery to one of robustly tracking and refining this prior to optimize for stability and task success.

When the imitation learning path is chosen, a source of expert or “teacher” data is selected (as shown in block 4050), which provides the reference motions that the policy will be rewarded for imitating. This data may come from a variety of high-quality sources. One potential source is libraries of motion capture (MOCAP) data (as shown in block 4052), a random sample of which may include infeasible movements for the robot 1 that must be filtered or adapted. This category may also include data collected directly from wearable training apparatus while an operator performs motions with the robot 1, or without being connected to the robot 1 in a “robot-free” mode. This particular robot-free data can be beneficial because it captures the specific movement patterns, potential sensor noise, and kinematic constraints of the wearable training apparatus, allowing the policy to learn a mapping that is pre-adapted to the idiosyncrasies of the physical control interface. Another source may be a model predictive control (MPC) engine (as shown in block 4054), which may be a proprietary controller highly customized to the specific dynamics and kinematics of the robot 1. The benefit of such an engine is its ability to automatically generate a large quantity of high-quality, dynamically feasible task poses and trajectories that are guaranteed to be achievable by the robot 1, serving as a perfect “teacher” for stable and efficient motion. Similarly, a dedicated, in-house trajectory optimization engine (as shown in block 4056) may be used. For any given task pose, this optimizer can automatically generate a trajectory that is not just feasible but optimized for specific criteria such as energy efficiency, smoothness, or speed. This provides the learning agent with examples of not just “good” but “best” ways to perform a task, instilling a higher degree of quality into the learned policy. Other sources (as shown in block 4058) may also be used, such as kinematically-planned motions, procedural animations, kinesthetic teaching where a human physically guides the robot through a motion, or even curated successful trajectories from previous RL training runs, to further enrich the library of teacher data.

Following the selection of a data source, the nature of the imitation task is further defined (as shown in block 4060). This step may involve an experimental comparison where different policies are trained to imitate reference trajectories of varying richness to determine which level of detail in the teacher's demonstration is most beneficial for learning. The options correspond to providing the learning agent with reference data that includes different combinations of “privileged” information available in the simulator besides the initial and target poses. For example, in option A (as shown in block 4062), the reference trajectory may only contain target joint positions. In option B (as shown in block 4064), the reference data may be richer, including both target joint position and velocity. In option C (as shown in block 4066), the reference may be even more detailed, providing target joint position, velocity, and torque. By comparing the performance of policies trained on these different imitation targets, a determination can be made regarding the optimal level of detail in the demonstration data to produce the most robust and capable final policy. Once the imitation strategy is defined, the process proceeds to the main training loop to train the policy (as shown in block 4048).

iii. Main Training Process

FIG. 13 illustrates the core iterative loop where the policy is trained. This process may continue for millions or even billions of timesteps until the policy's performance converges. At the beginning of each training episode, the simulator environment is reset (as shown in block 4070). This reset process may involve setting the robot to a specified initial pose (as shown in block 4082), potentially using a technique such as Reference State Initialization where the starting pose is a random point along a reference trajectory. A new target pose is set for the current episode (as shown in block 4084), providing a new task command to the policy. To enhance the robustness of the learned policy and improve its ability to generalize to a physical robot, a process of domain randomization is applied (as shown in block 4086). The primary goal for this randomization is to bridge the “sim-to-real” gap, which is the inevitable discrepancy between the idealized physics of a simulator and the complex, noisy dynamics of the real world. By training the Alpha model across a wide distribution of simulated conditions instead of a single, fixed environment, the policy can be forced to learn a control strategy that is invariant to minor physical variations, thus making it more robust when deployed on the physical hardware. The disturbances added during domain randomization may be extensive and may include variations to the robot's own properties, such as its geometry (e.g., arm length, hand weight), mass distributions, motor characteristics (e.g., friction, torque limits), and sensor noise or delays, as well as its controller parameters (e.g., control frequency, PD controller stiffness). The properties of the environment may also be randomized, such as the ground friction or the slope of the terrain. Furthermore, the policy may be subjected to random external forces of varying magnitude and direction to simulate unexpected pushes or perturbations to the robot 1. By learning to succeed despite these varied and unpredictable conditions, the policy becomes inherently more robust and adaptable.

With the environment reset and randomized, the policy is trained within the simulator (as shown in block 4080) in an inner loop of interaction. In this loop, the policy first observes the current robot state, sₜ (as shown in block 4082). Using this state, the policy selects an action aₜ, according to its current learned behavior π(aₜ|sₜ) (as shown in block 4084). This action is then executed in the simulator (as shown in block 4086). The simulator then transitions to the next state, sₜ₊₁, and the reward function is used to calculate the reward, rₜ, for the action taken (as shown in block 4088). This collected experience, in the form of (sₜ, aₜ r₁ sₜ₊₁) tuples, is stored in a replay buffer, and the system determines if a predetermined update interval has been reached (as shown in block 4090). If the interval is reached, a batch of data is sampled from the replay buffer to compute policy and value losses, and the network weights are updated via an optimization algorithm like gradient descent (as shown in block 4092). This inner loop of interaction and potential updates continues until the episode terminates.

At the end of an episode, the system checks if the episode ended in success or failure (as shown in block 4094), for example, if the robot successfully completed the task or if it fell. The system then loops back to reset the environment for a new episode. This entire training process continues until the policy's performance converges, at which point the final, converged Alpha model with the trained policy is output (as shown in block 4096), ready for deployment as part of the BAM to the robot 1.

b. Deployment of BAM

FIG. 14 illustrates an exemplary embodiment of a deployed three-layer hierarchical bipedal action model (BAM) 4508, and its operation corresponds to the running BAM on a robot for data collection step 3030 in the process 3000 of FIG. 10. This system 4500 is likewise designed to process multimodal inputs to generate complex, multi-stage behaviors for a humanoid robot. These inputs continuously feed into the model, primarily consisting of robot sensor data 4505, which may include a history of recent image frames from onboard cameras and proprioceptive state information such as joint angles, and a user input 4506, which may be a high-level command expressed in natural language such as “clean up the house.” This raw sensory and command data may be processed by a series of encoders before being passed to the first layer of this hierarchical model, the Gamma Model 4503, to initiate the process of reasoning and action generation.

The highest layer of the hierarchy, the Gamma Model 4503, is responsible for high-level semantic reasoning and long-horizon planning. This model may be a large vision-language model (VLM) with a substantial parameter count, potentially between 500 million and 200 billion parameters, built upon a foundation model pretrained on internet-scale data. Configured to operate at a relatively low frequency, for instance, between 0.1 Hz and 20 Hz, this “slow thinking” layer may receive the natural language instruction 4506 and decompose it into a sequence of intermediate goals or sub-tasks. For example, the command “clean up the house” may be broken down into “go to the kitchen,” “pick up the trash,” “go to the living room,” “pick up the toys,” and so on. This model may output these sub-tasks in the form of natural language descriptions or as abstract latent representations, referred to as z latent space, which are then passed down to the next layer in the hierarchy, the Beta Model 4502.

The middle layer, the Beta Model 4502, operates at a higher frequency, for instance, between 1 Hz and 20 Hz, and functions as a short-horizon planner or a “fast thinking” policy. This model may be a smaller, specialized VLA model, perhaps with 100 million to 10 billion parameters, that is finetuned for the specific morphology and capabilities of the robot 1. It receives the high-level sub-task from the Gamma Model 4503 (e.g., “pick up the trash”) and translates it into a sequence of more concrete, task-space actions. These actions may be expressed in a human/robot task space, such as target end-effector poses (e.g., “move hand to [x, y, z],” “close gripper”), base velocity commands (e.g., “walk forward at 0.5 m/s”), or specific gaze targets (e.g., “look at the trash bag”). This Beta Model 4502 effectively bridges the gap between abstract semantic goals and the immediate physical objectives required to achieve them, passing these task-space commands to the lowest layer, the Alpha Model 4501.

The lowest layer of the hierarchy, the Alpha Model 4501, is the real-time, low-level motion controller for the robot 1. This Alpha Model 4501 may be the model trained during the offline process 3020 (see e.g., FIG. 10) and represents the final, converged output of block 4096 of the offline RL training process detailed in FIG. 13. As a result of this extensive offline training, the Alpha Model 4501 is already a highly capable and robust policy, able to execute commands while inherently ensuring that the robot maintains balance, remains stable, and operates within all designated joint limits. Operating at a high frequency, for example, between 20 Hz and 1000 Hz, this model can receive the task-space commands from the Beta Model 4502 (e.g., “move hand to [x, y, z]”) and the current robot state 4505. Its function is to translate these immediate goals into the final, low-level motor commands, such as target joint positions, velocities, or torques, that can be sent directly to the robot's actuators. This model ensures that the commanded actions are executed in a way that is dynamically feasible, stable, and responsive to the immediate physical state of the robot and its environment.

In some embodiments, this Alpha Model 4501 may itself be a hierarchical policy; it receives the task-space commands from the Beta Model 4502, internally generates a dynamically feasible, whole-body joint-space trajectory (thereby performing the function of Beta Model 4502), and then tracks that internally-generated trajectory to output low-level motor torques and velocities while ensuring balance and stability (thereby performing the function of Alpha Model 4501). In an alternative embodiment, the Alpha Model 4501 may be implemented as a single, end-to-end policy that directly maps the task-space action tokens from the Beta Model 4502 and the current robot state into low-level motor commands (e.g., torques or velocities) without an explicit intermediate trajectory generation step. This model would be trained to simultaneously solve the planning problem and the control problem. The trade-off for this architectural simplification may be a more complex training process and potentially reduced modularity, as the planning (L2 layer) and control (L1 layer) functionalities can be entangled within a single model 4501. This may necessitate more complex reward shaping or imitation learning strategies to successfully train the combined policy.

c. Online RL Finetuning of BAM

Following the completion of the initial policy acquisition in the offline stage (e.g., process 3020 in FIG. 10, detailed in FIGS. 11-13) and the deployment of the trained Alpha model 4501 within the BAM 4500 (as shown in FIG. 14), the overall process 3000 may proceed to the online finetuning stage (e.g., block 3040 in FIG. 10)). This finetuning process may be based on data collected (e.g., block 3030) by running the BAM on a real robot to perform trained tasks. This data collection may involve a failure identification or probing phase, where the base BAM policy is deployed in the real world, potentially with safety constraints or a human-in-the-loop. When the base policy fails to complete a task or sub-task, the specific state and action sequence leading to the failure may be recorded.

This failure data may then be utilized for self-correction data generation. In some embodiments, a component of the BAM framework, such as the “thinking system” Gamma Model 4503 or the Beta Model 4502, may be used to reflect on the failure, potentially using a chain-of-thought strategy to identify the causes of the action failures. Based on this reflection, the BAM, or the model with human intervention or expert feedback, may generate a sequence of corrective actions or a complete recovery behavior to successfully complete the task. These successful recovery trajectories, which may include the initial failure states and the subsequent successful corrective actions, may then be curated. This curated “self-correction data” forms a valuable dataset for the subsequent RL finetuning step 3040.

During the finetuning process 3040, the curated self-correction data may be used in an RL framework to finetune the VLA model, which may include any or all layers of the BAM 4508. The RL methodologies applied in this online finetuning stage may be similar to those employed during the offline training. For example, a reward signal may be defined where the self-correction data provides implicit or explicit positive rewards for successful recovery behaviors, and negative rewards or a lack of positive reward for the failed attempts. A reward model may be trained on these successful and failed trials. The objective of this finetuning is to reinforce the desired, successful actions and diminish the likelihood of repeating the initial failures.

This finetuning process may also leverage reward functions with similar components to the offline stage, such as rewarding joint accuracy, smoothness, momentum, balance, and energy efficiency, but now applied to data gathered from real-world interactions. In some implementations, consistency-based objectives may be employed to ensure the finetuned policy remains sufficiently close to the initial demonstrations for stability, while also allowing for high-reward exploration in the identified failure scenarios. This entire process may be iterative, where the improved, finetuned policy is deployed again to collect more data (block 3030 in FIG. 10), thereby further refining its self-correction abilities and overall robustness. In some embodiments, the “specialist” policies, which represent the learned corrective behaviors, may be distilled back into the generalist BAM policy to create a single, more robust model for final deployment (block 3050 in FIG. 10).

FIG. 15 is a flowchart of a process 3040 for the online finetuning of a BAM with RL techniques on a humanoid robot, corresponding to step 3040 in FIG. 10. The process 3040 can be performed by the computing architecture 1000 of the humanoid robot 1. As another example, the process 3040, or portions thereof, can be performed by the remote AI system 2780. In some implementations, the process 3040 can be performed by any other computing system, cloud-based system, edge or online system, offline system, and/or network of computing devices. For illustrative purposes, the process 3040 is described from the perspective of a computer system performing this online end-to-end RL finetuning to further improve task performance, particularly by finetuning the BAM based on failure and self-correction data.

Referring to the process 3040 in FIG. 15, the computer system can begin the process as part of finetuning the BAM based on data collected from deploying the initial BAM on the humanoid robot (e.g., block 3030 in FIG. 10). Thus, the computer system can execute the BAM at the robot 1 with the goal to complete task A (block 5002).

FIG. 16 is an illustrative example of tasks performed by a humanoid robot, such as the robot 1 described herein, using the RL-trained BAM to complete a task A. In this example, task A can require the robot 1 to move a piece of metal 5250 from a rack 5251 to a jig 5252. The robot 1 can succeed at completing task A if it moves the metal 5250 from the rack 5251 to the jig 5252 without making mistakes and thus without self-correcting. If the robot 1 is successful in completing task A, the robot 1 can proceed directly to task Y, in which the robot 1 performs a reverse task. In other words, the robot 1 can be tasked with moving the metal 5250 from the jig 5252 back to the rack 5251. If the robot 1 is successful in performing task Y without making mistakes and thus without self-correcting, the robot 1 proceeds directly from task Y to task A.

Referring to task A, if the robot 1 makes a mistake and thus does not complete task A, it can self-correct. Self-correcting can include determining and performing any quantity of tasks (e.g., sub-tasks, actions) B-N to complete task A (and thus reach task Y). As an illustrative example, when moving the metal 5250 from the rack 5251 to the jig 5252 for task A, the robot 1 drops the metal 5250 on the ground. The robot 1 can detect that it has failed to complete task A and thus self-correct. This self-correction can include determining and performing a task B to pick the metal 5250 up off the ground and position it on the jig 5252. As described herein, the robot 1 can self-correct by analyzing its memory for data associated with the original task A and a current location of the robot 1 and/or the metal 5250 relative to the jig 5252. As a result, the robot 1 can determine what actions should be taken to move the metal 5250 from the current location on the ground to an endpoint, which is the jig 5252. Next, in this illustrative example, the robot 1 can detect that it has not properly aligned the metal 5250 with the jig 5252 after it picks the metal 5250 up off the ground and brings it over to the jig 5252. The robot 1 determines that it has failed to complete task A and again self-corrects. This self-correction can include determining and performing another task, such as task N, to move the metal 5250 until it is properly aligned with the jig 5252. At this stage, the robot 1 can detect that it has completed task A. Since task A is completed, the robot 1 can proceed to perform task Y (returning the metal 5250 to the rack 5251). In some implementations, the robot 1 can stop once the task A is completed—in other words, the robot 1 may not perform task Y.

Similarly, referring to task Y, if the robot 1 makes a mistake and does not complete task Y, it self-corrects by determining and performing any quantity of tasks B-N′ to complete task Y (and thus return to task A). Tasks B-N and B-N′ are therefore determined and performed by the robot 1 as part of a failure mode, so that the robot 1 learns how to appropriately complete the original task A and task Y, respectively, in real-time.

Referring back to FIG. 15, the computer system can collect data for a first dataset based on executing the BAM to complete the task A (block 5004). The data can be collected by the sensors 1.2.8 described in at least FIG. 4 above. The data can additionally or alternatively be collected by sensors that are external to the robot 1, such as environmental sensors, motion sensors, and/or imaging sensors/cameras that are positioned in the environment where the robot 1 is operating. The collected data can include data indicating actions and/or movements performed by the robot 1 whilst completing the task A.

In block 5006, the computer system can determine whether (i) the robot 1 completed the task A and (ii) a range of motion for the joint is permitted. The computer system can, in some implementations, apply one or more machine learning or AI models that are configured to determine whether the robot completed the task A. In some examples, the computer system can receive a notification or other information from the robot 1, which indicates whether or not the robot completed the task A. As another example, the computer system can obtain image data in block 5004 and process the image data using image recognition and/or object detection techniques to determine whether the task A has been completed. With regard to (ii), the computer system can determine whether any joint limit constraints that may be active were sufficient and accounted for a complete range of motion that is permitted for the particular joint or joints of the robot 1.

If yes to both in block 5006, the computer system can proceed to block 5016, described below. If the answer is no to either one of (i) and (ii) in block 5006, the computer system proceeds to block 5008, in which the computer system collects data for a second dataset based on the robot 1 performing a self-correct task B to complete task A. As described in reference to FIG. 16, as previously described, the robot 1 can realize, by processing historical data stored in its memory, that it did not complete the task A. Processing the historical data in memory can include performing image recognition and/or object detection techniques to determine whether the sheet metal has been moved from the rack to the jig and aligned within the jig. Processing the data in memory can also include determining and comparing a location of the robot 1 and/or the metal relative to the jig to determine whether and how much the robot 1 would have to move the metal to be properly aligned with the jig. In the example of the process 3040, the robot 1 can determine that it did not successfully move the sheet metal from the rack to the jig. Instead, as an example, the robot 1 may have dropped the metal on the ground. The robot 1 can execute the BAM to self-correct this error, thereby performing the self-correct task B. The self-correct task B, in this illustrative example, can include picking up the metal from the ground and placing it on the jig. As the robot 1 performs these tasks, the computer system collects the data for the 2nd dataset.

In block 5010, the computer system can determine whether (i) the robot 1 completed the task A based on performing the self-correct task B and (ii) the range of motion for the joint is permitted. Refer to block 5006 for further discussion about this determination. If yes to both in block 5010, then the computer system proceeds to 5016 described below. If no to one of (i) and (ii), then the computer system performs block 5012, in which the computer system collects data for a n^{th} dataset based on the robot performing a self-correct task N to complete task A. At block 5012, the robot 1 can determine, based on processing data in its memory, that it did not complete task A. In other words, when the robot 1 placed the metal on the jig, it did not properly align the metal in the jig. The robot 1 can execute the BAM to self-correct this error, thereby performing the self-correct task N. As the robot 1 performs the self-correct task N, the computer system collects the data for the nth dataset.

The computer system can perform blocks 5008-5012 as many times as needed to self-correct and complete task A, generating a 2^{nd}, 3^{rd}, . . . n^{th} dataset. As a result, the robot 1 may eventually complete task A through a series of self-corrections. However, in certain situations, a human may intervene in the training because the sub-tasks are too far afield of the desired training goals. For example, if the sheet metal was dropped on the ground and then kicked under the jig. Allowing the robot 1 to try and retrieve the sheet metal from under the jig may damage the robot 1 due to the jig's ability to move, and/or learning steps of retrieving the metal from under the jig is not beneficial in the overall training of the robot 1 in light of the rare number of times this may happen and/or the value of learning this task in comparison to the amount of time the robot spent learning the task.

In block 5014, the computer system can determine whether (i) the robot 1 completed the task A based on performing the self-correct task N and (ii) the range of motion for the joint is permitted. Refer to block 5006 for further discussion about this determination. If yes to both in block 5014, then the computer system proceeds to block 5016. If no to one of (i) and (ii) in block 5014, then the computer system may return to block 5002 and restart the task with all the data that has been collected up to performing block 5014. As a result, the computer system can automatically perform iterative layers of testing until the BAM achieves a threshold level of accuracy.

In block 5016, the computer system can finetune the initial BAM with reward-based learning methods using the 1st through nth dataset. This collected data, especially the datasets from block 5008 and block 5012, represents valuable information on failure modes and successful self-correction strategies, which can be used to improve the BAM's robustness. The reward-based learning methods employed in block 5016 can be any type of RL, including any described above. It should be understood that in other embodiments, the finetune the initial BAM or the generation of a revised BAM can be also accomplished using either: (i) only the data from successful completion of the task, or (ii) a combination of the data from successful completion of the task and data from non-successful completion of the task.

The finetuning, revising, or generation of a revised BAM of block 5016 can be system-based and/or feedback-based. For example, the computer system can finetune based on human feedback (block 5020). The human feedback can be provided by relevant users at computing devices. The feedback can indicate actions, tasks, and/or sub-tasks that should be performed or are preferred to be performed by the robot 1 to complete the task A. Additionally or alternatively, the computer system can finetune based on using an automated labeling model (block 5022). The model can be trained by the computer system or another computing system to automatically annotate data, such as the data from the first through nth dataset, based on analyzing and identifying visual features in image data and/or semantic context. Computer vision techniques, natural language processing, and/or machine learning can be used by the auto-labeling model to identify and annotate features in the data that can indicate whether actions or tasks have been performed or are being performed. The auto-labeling model can reduce the need for human review of the datasets for purposes of finetuning the BAM, which can result in more efficient processes. In some implementations, the finetuning can include a combination of the human feedback and annotations from the auto-labeling model.

Additionally or alternatively, the computer system can finetune the model in block 5016 based on binary decision feedback (block 5024). The binary decision feedback can indicate whether the robot 1 succeeded or failed at completing the task or a sub-task. If the robot 1 failed, for example, the computer system can implement the reward-based learning methods to adjust the BAM so that, during a next run, the robot 1 can succeed. Additionally or alternatively, the computer system can finetune based on scored decision feedback (block 5026). The scored decision feedback can include a numeric value indicating whether the robot 1 completed the task and/or how well the robot 1 completed the task (e.g., whether the robot 1 completed the task with the best possible path, the worst path, an okay path, a good path). A higher score can indicate that the robot 1 completed the task with a good to best possible path. A lower score can indicate that the robot 1 completed the task with a worse path or did not complete the task. The score value can indicate to the computer system what extent of finetuning may be suitable. Additionally or alternatively, the computer system can finetune based on comparative decision feedback (block 5028). The comparative decision feedback can include decisions and/or choices that were made by the robot 1 whilst attempting to complete the task, such as the task A and any of the self-correct sub-tasks discussed above. For example, when the robot 1 determines that it failed to complete the task A, the robot 1 can choose between 2 path options as the self-correct task B. The robot 1 may chose a first of the 2 path options because the robot 1 assumes that the first path is the best choice to complete the task A (when in reality, completing the first path does not cause completion of the task A, so the robot 1 has to perform self-correct tasks C-N to complete the task A). Finetuning the BAM according to the feedback in block 5028 can include assessing the path options that the robot 1 could have selected relative to the path that the robot 1 ended up selecting. The computer system can finetune or otherwise retrain the BAM based on the assessment.

In block 5030, the computer system can execute the finetuned BAM at the robot 1 to perform the task A again. The BAM can be finetuned (block 5016) and then used to re-run the task according to one or more of blocks 5020-5028. The BAM can be executed in block 5030 to re-evaluate its performance on the same task A, until a threshold level of accuracy is reached, as described further in reference to block 5032. Data can be collected for new datasets in response to executing the finetuned BAM.

In block 5032, the computer system can then determine whether (i) the finetuned BAM's success rate is over a threshold level and (ii) the range of motion for the joint is permitted. The threshold level can indicate a desired level of accuracy, for example, within a range of 99% to 100%. The threshold level can be different and/or higher than the threshold level of blocks 5006, 5010, and/or 5014. In some implementations, the threshold level can be the same. If yes to both in block 5032, the computer system can deploy the BAM (block 5034). This corresponds to the final output block 3050 in FIG. 10. If no to either one of (i) and (ii) in block 5032, the computer system can return to block 5002 and continue to collect data and finetune the model with all the data that has been collected up to and/or including block 5032.

FIG. 17 is an example decision tree 3400 of a RL-trained BAM that is deployed at the humanoid robot 1 to complete an example task A. In the decision tree 3400, instructions can be executed at the robot 1 to complete the task A. If the robot 1 succeeds at performing task A (refer to FIG. 16 for an illustrative example), then the robot 1 can proceed to complete the next task, task Y. If the robot 1 fails at completing task A, then the robot 1 enters a failure mode and determines and performs tasks B-N until the robot 1 completes the task A. Once the robot 1 completes the task A, which may be by determining and performing the tasks B-N in the failure mode, the robot 1 proceeds to complete task Y.

If the robot 1 succeeds at performing task Y (refer to FIG. 16 for an illustrative example), then the robot 1 can proceed to complete task A again. In other words, the robot 1 can redo training with the data that was collected when the robot 1 previously worked through the decision tree 3400 workflow. To complete task A again, the robot 1 may first work back from task Y to task A. As an illustrative example, if task A was moving a piece of metal from a rack to a jig, then task Y can be moving the piece of metal from the jig back to the rack. Thus, if task Y is completed successfully, the robot 1 has returned the piece of metal to the rack. Then the robot 1 can perform task A again (moving the piece of metal from the rack to the jig) with the data that was collected when the robot 1 initially performed and completed task A. If the robot 1 fails at completing task Y, then the robot 1 enters a failure mode and determines and performs tasks B-N′ until the robot 1 completes the task Y. Once the robot 1 completes the task Y, which may be by determining and performing the tasks B-N′ in the failure mode, the robot 1 has succeeded, and can return to completing task A, as described above.

### F. Industrial Application

Optimization is physically grounded and machine-internal. The runtime cost function minimizes concrete, measurable quantities such as energy consumption (derived from bus voltage/current telemetry), time to completion (from synchronized clocks), predicted mechanical wear (weighted by joint travel, torque, and temperature), distance traversed, and battery state-of-charge. The system continuously re-evaluates these costs from live telemetry and re-plans trajectories and contact schedules accordingly, yielding smoother paths, reduced drift over long horizons, lower energy per task, and extended component life. Because these costs originate from hardware sensors and constraints and drive actuator-level outputs, the optimization constitutes a technical process for improving machine efficiency, not an abstract data manipulation.

The training and deployment pipelines are likewise technical and hardware-constrained. The beta/alpha models are co-trained end-to-end on layered datasets that include synchronized teleoperation traces with ground-truth torque/position logs, physics-engine simulations calibrated to the robot's actual mass/inertia parameters, and perception datasets captured by the same sensor suite used at inference. Training labels include physically meaningful cost targets (e.g., energy/time/wear) and contact events, which align model outputs with controllable motor commands rather than abstract classifications. The deployed models are compiled and quantized for the onboard NPU/GPU with fixed-point or mixed-precision kernels validated against hardware-in-the-loop tests to satisfy cycle-time and jitter requirements. These constraints and validations are specific to the disclosed machines and ensure that inference directly produces safe, stable actuator signals under real-time deadlines.

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a wheeled robot with a torso and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/352,959, 19/355,393, 19/321,022, 19/355,531, 19/355,786, 19/357,879, 19/358,414, 19/362,617, and 19/363,293; and (iii) U.S. Design Patent Application Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A method for controlling a humanoid robot using a hierarchical bipedal action model (BAM), the method comprising:
obtaining a base controller by training in simulation with reinforcement learning;
instantiating an initial BAM including a Gamma model configured to generate intermediate goals, a Beta model configured to translate the intermediate goals into task-space actions, and a Alpha model configured to translate the task-space actions and robot state into motor commands;
deploying the initial BAM such that at least the Alpha model executes on-board the humanoid robot;
causing the humanoid robot to perform an initial task and logging sensor and control data to form a first dataset;
based on the first dataset, training at least one policy of the BAM to generate a refined BAM; and
deploying the refined BAM to control the humanoid robot autonomously.

2. The method of claim 1, wherein the simulation training employs domain randomization of robot and environment parameters including one or more of geometry, mass distribution, actuator limits or friction, contact properties, and exogenous perturbations, and wherein a reward function includes at least a joint-pose accuracy term.

3. The method of claim 1, wherein the high-level, mid-level, and low-level policies operate at different update rates with the Alpha model updating more frequently than the Beta model, and the Beta model updating more frequently than the Gamma model.

4. The method of claim 1, wherein the Gamma model is a multimodal model configured to decompose natural-language instructions into intermediate goals, and the Beta model is a vision-language-action model configured to output task-space actions including one or more of target end-effector poses, base velocity commands, and gaze targets.

5. The method of claim 1, further comprising: detecting a failure to complete the initial task;
autonomously generating one or more self-correcting tasks based on historical memory of the initial task and a current robot state; and collecting additional datasets while executing the one or more self-correcting tasks until the initial task is completed.

6. The method of claim 5, wherein generating the one or more self-correcting tasks comprises: (i) analyzing stored imagery and proprioception using object detection or state-estimation to determine task status, (ii) comparing current robot and object poses to target endpoints, and (iii) producing corrective action sequences to reach the target endpoints.

7. The method of claim 1, wherein training the refined BAM comprises reward-based learning using feedback selected from: human preference or ranking of actions, automated labeling model annotations identifying visual features, and scalar or binary task-success signals, and further comprises deploying the refined BAM upon satisfying an operator-specified success criterion.

8. The method of claim 2, wherein the reward function further includes one or more of: (i) angular-velocity consistency terms, (ii) momentum-management terms comparing centroidal linear and angular momentum to reference values, (iii) center-of-mass trajectory alignment, and (iv) energy-efficiency penalties based on torque-velocity power across joints.

9. The method of claim 1, wherein deploying the refined BAM comprises retaining the refined BAM in on-board memory for local execution and transmitting the refined BAM over a network for deployment on additional humanoid robots to enable fleet-wide updates.

10. A system for controlling a humanoid robot using a hierarchical bipedal action model (BAM), comprising:
a Gamma model configured to receive multimodal inputs and generate intermediate goals;
a Beta model configured to translate the intermediate goals into task-space actions;
a Alpha model configured to translate the task-space actions and robot state into motor commands; and
wherein the Alpha model is trained with a reward function including at least one of joint-pose accuracy, angular-velocity consistency, momentum management, center-of-mass trajectory alignment, and energy-efficiency terms.

11. The system of claim 10, wherein the Gamma model comprises a vision-language model operable on image sequences and proprioceptive inputs and outputs the intermediate goals as natural-language descriptions or latent goal representations.

12. The system of claim 10, wherein the task-space actions include target end-effector poses and base locomotion commands, and the motor commands include at least one of joint positions, joint velocities, and joint torques.

13. The system of claim 10, wherein the policies execute at different update rates with a relative ordering of high-level<mid-level<low-level.

14. The system of claim 10, wherein the reward function includes: an exponentially-weighted pose error term, a velocity-consistency term based on an L2 norm, and a centroidal momentum term comparing linear and angular momentum to reference trajectories.

15. The system of claim 10, wherein the Beta model receives the intermediate goals as abstract latent representations and outputs probability distributions over discrete action tokens representing manipulation or loco-manipulation primitives.

16. The system of claim 10, further comprising a safety monitor configured to override or gate lower-level commands when safety thresholds for joint-torque limits, contact forces, or stability margins are exceeded.

17. The system of claim 16, wherein the joint-torque limits are enforced with soft constraints that increase resistance as torques approach a configurable fraction of a rated maximum.

18. The system of claim 10, wherein the Gamma model includes a vision encoder for RGB sequences with temporal attention, a language encoder with bidirectional transformer layers, and a fusion module combining visual and linguistic representations.

19. The system of claim 10, wherein at least one policy is trained or fine-tuned using imitation data from one or more of motion capture, teleoperation demonstrations, model-predictive control trajectories, or trajectory optimization outputs.
